(19) United States
(12) Patent Application Publication
(10) Pub. No.: US 2026/0320503 A1
(43) Pub. Date: Oct. 15, 2026

(54) Backdoor and Hidden Bias Defense using Subspace Orthogonalization in Neural Networks

(71) Applicant: Anomalee Inc., State College, PA (US)

(72) Inventors: David Jonathan Miller, State College, PA (US); George Kesidis, State College, PA (US); Guangmingmei Yang, State College, PA (US)

(73) Assignee: Anomalee Inc., State College, PA (US)

(21) Appl. No.: 19/719,045

(22) Filed: Jun. 24, 2026

Related U.S. Application Data
(63) Continuation-in-part of application No. 18/909,902, filed on Oct. 8, 2024.
Application No. 18/909,902 is a continuation of application No. 18/485,956, filed on Oct. 12, 2023.
(60) Provisional application No. 63/415,597, filed on Oct. 12, 2022.
(60) Provisional application No. 63/422,894, filed on Nov. 4, 2022.
(60) Provisional application No. 63/462,201, filed on Apr. 26, 2023.
(60) Provisional application No. 63/852,617, filed on Jul. 28, 2025.

(51) Int. Cl. G06N 20/00

(52) U.S. Cl. CPC G06N 20/00

(57) ABSTRACT

Some embodiments of the disclosed techniques defend against backdoors and hidden biases in machine-learned models. During operation, a defense system defending against backdoors and hidden biases receives a machine-learned model. The defense system further receives a clean set of input samples for the machine-learned model and a corresponding set of correct responses. During operation, the defense system perturbs at least one of (1) the input samples of the clean dataset and (2) the activations of the input samples of the clean dataset in a shallow layer of the machine-learned model; perturbing produces a common incorrect model response by the machine-learned model. The defense system imposes an optimization penalty on the activations of a second layer of the machine-learned model that are induced by the perturbations, thereby detecting, inverting, and/or mitigating backdoors and/or hidden biases in the machine-learned model.

### RELATED APPLICATIONS

This application claims priority under 35 U.S.C. § 119 (e) to U.S. Provisional Patent Application No. 63/852,617, by inventors David Jonathan Miller and George Kesidis, entitled “Backdoor Inversion in Large-Language Models,” filed 28 Jul. 2025 (Attorney Docket No. ANOM-010-US-PR). This application is also a continuation-in-part of, and hereby claims priority under 35 U.S.C. § 120 to, pending U.S. patent application Ser. No. 18/909,902, entitled “Universal Post-Training Backdoor Detection and Mitigation for Classifiers,” by inventors David Jonathan Miller, George Kesidis, and Hang Wang, filed on 8 Oct. 2024 (Attorney Docket Number ANOM-009-US-CON). U.S. patent application Ser. No. 18/909,902 is a continuation of, and claims priority under 35 U.S.C. § 120 to, U.S. Non-provisional patent application Ser. No. 18/485,956, entitled “Universal Post-Training Backdoor Detection and Mitigation for Classifiers,” by David Jonathan Miller, George Kesidis, and Hang Wang, filed on 12 Oct. 2023 (Attorney Docket Number ANOM-009-US-NP). U.S. patent application Ser. No. 18/485,956 claims priority under 35 U.S.C. § 119 (e) to: (1) U.S. Provisional Patent Application No. 63/415,597, by inventors David Jonathan Miller, George Kesidis, and Xi Li, entitled “Detection and Classification Exploiting Radial Symmetry,” filed 12 Oct. 2022 (Attorney Docket No. ANOM-006_2-US-PR); (2) U.S. Provisional Patent Application No. 63/422,894, by inventors David Jonathan Miller, George Kesidis, and Hang Wang, entitled “Ensemble-Policy Active Learning for Classification and Regression,” filed 4 Nov. 2022 (Attorney Docket No. ANOM-008-US-PR); and (3) U.S. Provisional Patent Application No. 63/462,201, by inventors David Jonathan Miller, George Kesidis, and Hang Wang, entitled “Backdoor-Agnostic Post-Training Backdoor Mitigation for Deep Neural Network Classifiers,” filed 26 Apr. 2023 (Attorney Docket No. ANOM-009-US-PR). The contents of all of the above-referenced applications are hereby incorporated by reference.

### GOVERNMENT LICENSE RIGHTS

This invention was made with Government support under Grant No. 2132294, awarded by the National Science Foundation to Anomalee, Inc. The government has certain rights in the invention.

### BACKGROUND

### Field of the Invention

This disclosure generally relates to techniques for secure and robust deep learning. More specifically, this disclosure relates to detecting and mitigating malicious backdoor data-poisoning or natural backdoors or biases in Deep Neural Networks (DNNs).

### Related Art

Machine-learning techniques facilitate building models based on sample data (e.g., “training data”) that can then be used to make predictions or decisions. Machine-learning techniques are becoming increasingly used in a wide variety of applications, such as email filtering, image and text generation, audio processing, and computer vision, in which leveraging conventional techniques to perform a given task is difficult or infeasible. Analysis performed upon the sample data determines a set of trends and/or underlying characteristics that are then used to configure and train the AI, which can then be used to make decisions for new sets of (non-training) data.

However, because such techniques leverage training data for automated analysis and generation of models, they can be vulnerable to data poisoning. Backdoor data-poisoning attacks seek to embed subtle backdoor patterns, called backdoor triggers, into training samples. These may not be noticeable to humans but can change the outputs of the AI to suit the goals of an attacker. For AIs used as classifiers, the attack seeks to cause the decided class to be an attacker-designated “target class” whenever the trigger is embedded into a sample from one of a set of “source classes”. If all classes other than the target class are source classes, the attack is “all-to-one”. If the attack involves a single (source, target) class pair, the attack is “one-to-one”. More generally, the attack could be L-to-1, L<K, where K is the number of classes. These attacks, sometimes called Trojans, may leverage a huge variety of possible backdoor patterns and methods for incorporating triggers into samples, making the detection of backdoor data poisoning very challenging.

Hence, what is needed are techniques and systems for detecting backdoor poisoning in a machine-learned decision-maker without the problems of existing approaches.

### SUMMARY

The disclosed embodiments disclose techniques for improving nominal defenses against backdoor attacks and non-malicious hidden biases in machine learned models, particularly deep neural networks (AIs) including classifiers for different types of media, and generative large-language models (LLMs). This includes deep neural networks (DNNs, also called “AIs”) acting as classifiers for data modalities that include images, video, point clouds, time series, and text (LLMs). Some embodiments leverage class subspace orthogonalization (CSO) techniques to augment nominal defenses by limiting the effects of discriminating features of the putative target response, for example, when attempting to invert a backdoor in a large-language model.

Backdoors can be planted while the training dataset is being formed prior to the model being trained (during which its parameters are learned) or during an online active learning or online reinforcement learning process, used to dynamically refine the model. Some embodiments of the present invention operate unsupervised, post-training (without access to the training dataset) to detect and mitigate backdoor data-poisoning of machine-learned models (particularly a deep neural network (DNN) classifier or Large Language Model (LLM)) and to perform test-time (online, operational) detection of backdoor triggers. This “post-training” scenario, where the defense has no access to the training set that was used to learn the model, is of great practical significance, as it applies both i) when the purchaser of the model/AI lacks “data rights” (lacks access to the training set) and ii) when a small company fine-tuning a foundation model for a custom application would like to certify that the model is backdoor-free before using it. Moreover, unlike many existing backdoor detectors and mitigators, some embodiments of the present invention do not make any assumptions about the backdoor pattern or its method of incorporation into training and test samples, and seek to detect and mitigate effectively irrespective of the backdoor pattern and the method of its incorporation chosen by the attacker. In this sense, such embodiments of the present invention are “backdoor agnostic” or “backdoor universal,” in addition to being applicable to different models for classification or clustering (including ensembles of models). Detection of backdoor poisoning of the DNN in some embodiments does not require clean (unpoisoned) samples, while mitigation and backdoor trigger detection at test-time do leverage a small clean (correctly labelled and not maliciously modified) dataset. Some embodiments of the present invention can be applied to detect or mitigate non-backdoor (“error generic”) poisoning of the training dataset or non-malicious model biases due to problems such as inadequacies of the training set, class imbalances in the training dataset, as well as due to over-fitting or under-fitting to the training data.

For detection, some embodiments rely on the principle that, in order to consistently classify backdoor poisoned training samples (and consequently backdoor trigger test samples) to the target class of the attack, DNN training tends to overfit to the backdoor pattern, so as to overcome the source-class discriminative features which are also present in the backdoor-poisoned training samples. The implication of such overfitting is that the maximum classification margin (decision-confidence based on the output class logits) for a backdoor target class will tend to be much larger than that for a non-target class. Thus, some embodiments detect backdoors by hypothesis testing using the maximum classification margin statistics for all classes. Some embodiments' backdoor mitigation techniques leverage a clean dataset to limit the allowed internal activations of a DNN. This is consistent with a principle of security that seeks to prevent activity which is extraneous to the designed behavior of a system (here, the “normal” range of activations induced by a clean (validation) set). Some embodiments jointly operate both the unmodified and the backdoor-mitigated DNNs to detect backdoors operationally (at test/inference time) when their class decisions differ, particularly when the unmodified DNN classifies to the detected target class.

The disclosed embodiments disclose techniques for defending against backdoors and hidden biases in machine-learned models. During operation, a defense system defending against backdoors and hidden biases receives a machine-learned model. The defense system further receives a clean set of input samples for the machine-learned model and a corresponding set of correct responses. During operation, the defense system perturbs at least one of (1) the input samples of the clean dataset and (2) the activations of the input samples of the clean dataset in a shallow layer of the machine-learned model; perturbing produces a common incorrect model response by the machine-learned model. The defense system imposes an optimization penalty on the activations of a second layer of the machine-learned model that are induced by the perturbations, thereby detecting, inverting, and/or mitigating backdoors and/or hidden biases in the machine-learned model.

In some embodiments, the machine-learned model is a neural network classifier, the second layer is deeper and distinct from the shallow layer and hence closer to a decision layer for the machine-learned model. A backdoor trigger and/or a hidden-bias trigger induce samples from a source class to a target class distinct from the source class. In such embodiments, the defense system further receives a nominal defense that minimizes an objective function over perturbations of the clean dataset for at least one of each putative target class and each putative source-target class pair. The defense system incorporates into a given putative target class's objective function a class-subspace orthogonalization penalty based on the internal activations of the machine-learned model at the second layer.

In some embodiments, the class-subspace orthogonalization penalty is based on a cosine similarity applied to activated features in the second layer. The cosine similarity discourages the minimization from choosing nominal class-discriminating-features, thereby reducing false positives and improving detection performance since backdoor and hidden-bias triggers typically do not possess discriminating features of the target class.

In some embodiments, the nominal defense is a detector of model backdoor poisoning and/or bias of the machine-learned model.

In some embodiments, the detector's objective for each putative target class is a measure of decision confidence to the putative target class, thereby indicating the decision confidence of the machine-learned model.

In some embodiments, detection is based on inversion of an estimated backdoor trigger and/or an estimated hidden bias trigger. Inversion comprises finding the estimated backdoor trigger(s) and/or the estimated hidden bias trigger(s) that are specific to a putative target class, through perturbations associated with clean dataset samples not from the putative target class.

In some embodiments, the cosine similarity penalizes perturbations that yield activated feature vectors that are in the direction from putative source-class samples to putative target-class samples.

In some embodiments, a nonnegative and nonlinear function of the cosine similarity is used.

In some embodiments, the cosine similarity involves soft class-specific masking of activated features.

In some embodiments, the nominal defense mitigates the backdoor trigger(s) and/or hidden bias trigger(s).

In some embodiments, the machine-learned model is a neural network classifier, and mitigation is by activation clipping and model-weights fine-tuning, thereby limiting activations associated with at least one of backdoor triggers and hidden bias triggers.

In some embodiments, the neural network model is a generative large-language model whose natural language prompt is converted to a sequence of tokens. The class subspace orthogonalization facilitates not only reduced false positives and increased true positives but also implicit blacklisting of tokens strongly associated with the putative target class.

In some embodiments, a common perturbation is used, and is an ordered token sequence. Furthermore, minimization of the detector's objective is by token-wise accretion with candidate down-selection after each token is added to the perturbation, and the nominal defense also directly inverts backdoor and/or hidden-bias triggers.

In some embodiments, a common perturbation is an ordered sequence of embedding vectors. Gradient-based continuous optimization is performed to choose the common perturbation, and the common perturbation is appended to the ordered sequence of embedding vectors produced by each of the clean input samples.

In some embodiments, the model is a generative large-language model and the target response is not one of the known responses for the given application domain. In such embodiments, the perturbations in the input or shallow layer are common for all clean samples. A consensus activation is sought in the deeper layer while penalizing against at least one of activations in the direction of known, nominal responses and posterior probabilities of known, nominal responses.

In some embodiments, the generative large-language model generates software. Furthermore, in some embodiments in which the generative large-language model generates software the unknown target response has zero-day malware.

### BRIEF DESCRIPTION OF THE FIGURES

FIG. 1A illustrates malicious backdoor poisoning against a DNN classifier in accordance with an embodiment.

FIG. 1B illustrates penalized perturbation directions in the context of the malicious backdoor poisoning illustrated inf FIG. 1A in accordance with an embodiment.

FIG. 2 illustrates an approach to defense against backdoor poisoning or non-malicious bias in accordance with an embodiment.

FIG. 3 illustrates the architecture of a transformer (attention-layer based) Large Language Model (LLM) in accordance with an embodiment.

FIG. 4 illustrates the exemplary performance of a new capability enabled by an embodiment.

FIG. 5 illustrates a computing environment in accordance with an embodiment.

FIG. 6 illustrates a computing device in accordance with an embodiment.

FIG. 7 lists mathematical expressions in accordance with embodiments.

FIG. 8 illustrates the effect on decision boundaries of backdoor poisoning of the training dataset in accordance with an embodiment.

FIG. 9 presents a flow chart that illustrates the process of defending against backdoors and hidden biases in a machine-learned model in accordance with an embodiment.

Table 1 illustrates a discrete trigger inversion and detection technique that uses J_t(q) as a score function in accordance with an embodiment.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or non-transitory medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, a full-custom implementation as part of an integrated circuit (or another type of hardware implementation on an integrated circuit), field-programmable gate arrays (FPGAs), a dedicated or shared processor that executes a particular software module or a piece of code at a particular time, and/or other programmable-logic devices now known or later developed. When the hardware modules are activated, the hardware modules perform the methods and processes included within the hardware modules.

### Deep Neural Networks (DNNs) and Backdoor Poisoning

Deep Neural Networks (DNNs), also known as Artificial Intelligences (AIs), have achieved state-of-the-art performance in various application domains involving large and complex datasets including: classification (e.g., of images, speech, or text), regression/prediction (e.g., denoising a signal), control (e.g., of a player in an artificial role-playing or board game, or of a complex real-world physical system), and generative modeling (e.g., video and large-language models). Note that, for simpler tasks, classification can be achieved by different machine-learned models such as support-vector machines (SVMs, in supervised fashion as for DNNs) or clustering models such as K-means, Gaussian mixture models, parsimonious mixture models, one-class SVMs, one-class DNNs, or DNN autoencoders (in unsupervised fashion). Also note that the action of, e.g., regression or control can also be interpreted as classification when a finite set of possible outputs/actions are involved or when that is achieved by output clustering or partitioning, e.g., quantization.

DNNs typically have an enormous number of parameters and a wide variety of architectures (models). Some commonly-used feed-forward, multilayer architectures for the case of the imaging domain include ResNet and LeNet, which have convolutional layers (with rectangular convolutional kernels). Other architectures have “attention” layers (e.g., transformer models), while still others are customized to specific applications (e.g., to exploit radial symmetry of objects of interest in images). DNN parameters are learned (i.e., the DNN is trained) typically by gradient-based minimization of a loss objective over the DNN's parameters, where the loss objective is typically additive over the commensurately large training dataset. For example, gradients of a cross-entropy loss function computed by back-propagation are used to learn a multi-layer DNN classifier; and if that classifier has units/neurons with memory in order to act on dependent sequential data then “back-propagation through time” can be employed. Rectified Linear Units (ReLUs) are used to expedite the deep learning process by avoiding the small-magnitude gradients that may occur when sigmoid-type neurons are used. Often much more costly and time-consuming than such (supervised) deep learning processes is the process through which the training dataset itself is formulated and subsequently curated. When deployed, a DNN may experience “model drift” and require parameter refinement through active learning or (online) reinforcement learning.

The formulation of the DNN architecture and the deep learning process itself are often heuristic considering the complexity of the data and the required highly “non-convex” nature of its input-output mapping. Thus, even after a long and costly deep learning process, a DNN may behave in unexpected ways when it is operationally deployed, i.e., at test time. Studies have shown how a DNN may make serious mistakes on specially crafted “adversarial” test samples (adversarial inputs), even though its behavior on the training dataset is acceptable.

Studies have also shown that trained DNNs may have hidden biases, e.g., predicting a cow is present in a scene that contains only grass because grass was predominantly present in the training set examples of scenes with cows. Such hidden biases are sometimes referred to as intrinsic backdoors or natural backdoors. That is, a natural backdoor occurs without malicious backdoor poisoning of the training dataset. Such backdoors may be an artifact of the training set, the DNN architecture, or the deep-learning process, or they may be an intrinsic aspect of the classification problem for the given domain.

Because of its necessarily enormous size, the task of producing elements of the training dataset (or even the training process) are often outsourced or involve a large amount of manual curation (as in offline Reinforcement Learning with Human Feedback or RLHF). Thus, there is significant potential for the training dataset to be maliciously poisoned. Additionally, poisoning can occur through an online active learning or online reinforcement learning process. The objective of such data poisoning could be to generally reduce the accuracy of the DNN (i.e., error-generic data poisoning) or to plant a backdoor (i.e., a Trojan), where the latter facilitates an adversarial input (e.g., a backdoor trigger at test time). It has been frequently observed that very little poisoning is required to plant an effective backdoor (with the possible exception of “clean label” backdoor poisoning).

For the example of a DNN classifier, backdoor poisoning may cause an input sample which belongs to one type of response or class (a source class of the backdoor attack) to instead be classified to a different class (a target class of the backdoor attack) when the backdoor pattern is incorporated into the sample. An effective backdoor attack is one where incorporation of the backdoor pattern results in only a subtle modification of the sample so as to evade detection either by automated means or by manual human inspection. Also, covert backdoor poisoning should not significantly impact the DNN's accuracy on clean data. For the case of unsupervised clustering (mapping input samples to different clusters where each cluster may correspond to a different component density function), the attack could alter features of a clean sample to add a backdoor pattern and weaken cluster/component-representative features of the clean sample (as in some “clean label” backdoor attacks on classifiers). In some embodiments of unsupervised clustering, a parsimonious mixture model could be applied to the embedded features of a DNN autoencoder.

Some embodiments provide a principled, practical, and effective way to detect and mitigate malicious backdoor data-poisoning (security) or natural backdoors or biases (robustness) in Deep Neural Networks (DNNs), including Large-Language Models (LLMs) and DNNs used as classifiers, as well as in other machine-learned models such as logistic regression, Bayesian network, or support-vector-machine-based classifiers. Such embodiments are relevant to adversarial learning and also to the field of explainable (or interpretable) AI (since it is fundamental to explainable AI to ascertain whether or not a DNN (or other machine learning model) is performing as intended, with backdoor-poisoned DNNs not performing as intended). Some embodiments of the invention are agnostic to the backdoor pattern itself and agnostic to the manner in which the pattern is incorporated into the poisoned training samples and into operational (test) samples. Since such embodiments do not assume any knowledge of the backdoor pattern and its method of incorporation, and since the disclosed techniques aim to be effective for a wide variety of backdoor patterns and methods of incorporation, such embodiments can be referred to as universal backdoor (Trojan) detectors and mitigators.

Regarding Large-Language Models (LLMs): In some applications (e.g., air traffic control, police and fire emergency dispatch, soldiers in the field) language is strictly regulated. Consider fine-tuning an LLM for a not-exhaustive set of scenarios X involving a set of well-defined words W, so that when the LLM is prompted with a given scenario in X it should yield a particular response composed of an unambiguously defined dictionary of special words in W. Also suppose that there is a finite set R of such responses. However, some elements of R may rarely occur, and some elements of R may not be known a priori. We thus have a classification problem of X to R and we can conceive of biases (both deliberately and inadvertently caused) or adversarial perturbations (both universal and prompt-context specific); i.e., prompts that trigger incorrect responses either in R or outside R. In particular, there could be prompts in a set X′ and not in X, that are very similar and semantically identical to a member of X, which could be deliberately triggered by a knowledgeable adversary, or inadvertently triggered by a human in a crisis setting, resulting in incorrect responses. Semantically-equivalent prompts should produce the same response even when they include some words not in X. Some embodiments identify such biases and address the robustness of an LLM that is fine-tuned on (X,R).

In some embodiments, class subspace orthogonalization (CSO) augmentation of a backdoor detector's objective function, either with token-wise accretion and downscaling or gradient-based optimization over the front-end token-embedding space, greatly improves detection and mitigation of backdoors (e.g., Trojans or maliciously planted biases) or non-malicious biases in LLMs. CSO techniques provide a “plug and play” capability that can improve a variety of nominal defenses with goals related to backdoor or bias detection and mitigation under different assumptions.

In some embodiments, the nominal defenses that CSO techniques improve upon work on deep neural network classifiers and generative LLMs to reverse engineer (invert) the backdoor trigger or bias if one is present. CSO improves upon these methods by restricting inverted triggers to be ones that do not induce internal (embedded, activation) space features that are discriminative of or representative of (intrinsic to) the putative target class/response of the attack.

In some embodiments, CSO improves post-training backdoor and bias detection and mitigation methods, including those of other embodiments of the present invention.

In some embodiments, CSO improves operational (test time) detection of backdoor or bias triggers.

In some embodiments, CSO improves detectors of backdoor poisoned or of biased samples in the training dataset.

In some embodiments, CSO is applied to Convolutional Neural Networks (CNNs). In other embodiments, CSO is applied to transformer models such as generative Large-Language Models (LLMs) with internal attention stages and whose responses are generated token-wise with autoregressive feedback.

Suppose that the detector's (maximized) objective function for class k∈K, Q_k, has two additive contributions, one from its intrinsic (representative) features (Q_ki) and another which is present if this class is the target class for a backdoor attack (Q_kb), i.e., Q_k=Q_ki+Q_kb. Suppose that there are 3 classes and that class 3 is the true target class of a backdoor attack. Suppose that class 1 has stronger intrinsic features than class 3, e.g., Q_1i=5, Q_2i=2, and Q_3i=1. Also, suppose that Q_3b=4, with Q_1b=Q_2b=0 since classes 1 and 2 are not backdoor target classes. Without suppressing intrinsic feature contributions, Q_1=Q_3=5. In this case, class 3's maximized objective is not an outlier, and thus there will be a missed detection. However, if we fully suppress intrinsic feature contributions while maximizing the detector's objective, Q_1i=Q_2i=Q_3i=0 and Q_1=Q_2=0 and Q_3=4; so in this case, class 3's objective function(treated as its detection statistic) will be a significant outlier, and thus a true detection will be achieved. Thus, the disclosed class subspace orthogonalization (CSO) techniques are plug-and-play methods-they involve modifying a given backdoor detector's objective function to include a CSO penalty term that penalizes against intrinsic feature contributions. Optimization of this modified detector objective (with a CSO penalty term) will effectively restrict the search to feature directions that are least positively correlated with (e.g., orthogonal to) the putative target class's intrinsic features. This approach is broadly applicable to any existing detector that solves an optimization problem to produce a detection statistic for each putative target class. Moreover, it can be applied regardless of whether the detector's optimization is over input features, internal features of the DNN, or over parameters that specify a putative backdoor trigger and its mechanism of incorporation within an input sample. Incorporating a CSO penalty term into the detector's objective function in general yields substantial benefits both in detection sensitivity (true detection rate) and specificity (false positive detection rate).

In some embodiments, for the case of Large Language Models (LLMs) for example, Blacklisted Accretion for Backdoor Inversion (BABI) greedily inverts backdoors or biases one discrete token at a time by applying CSO to rank and down-select at each token position. BABI is an embodiment that practically addresses the problem of searching over the enormous product space of possible LLM backdoor triggers. In other embodiments for LLMs, the optimization of the CSO-augmented detector objective function is performed by gradient descent working in token embedding space. In this case, the goal is simply to detect whether the LLM is backdoor-poisoned or not, not to invert the backdoor trigger.

Regardless of the domain (images, time series, point clouds, text), even given the constraint that the trigger be unobtrusive, there is an enormous set of possible backdoor trigger patterns and mechanisms for encoding the trigger into an input sample (also referred to as trigger embedding functions). For example, for images, encoding a trigger pattern could alter any subset of pixels in the image. Moreover, the trigger could be encoded, for example, additively, multiplicatively, by replacing an image patch with the backdoor trigger, by convex-combination blending of an image patch with the backdoor trigger pattern, through image warping, by combining multiple of these embedding mechanisms, or by myriad other means. This amounts to a vast space of possible unobtrusive backdoor attacks. For LLMs, the trigger could be an innocuous phrase (e.g., “Tell me seriously.”) inserted somewhere in the input prompt, but there are also stylistic backdoors, e.g., a particular pattern of bold, italics, and regular font applied to the words in the input prompt.

A Large Language Model (LLM) typically initially applies a parser and (one-hot encoded) tokenizer of the words in the user's prompt/input, e.g., SentencePiece used by the FLAN-T5 models [Hugging Face]. Let q=(q_1, q_2, . . . , q_M) be the sequence of (language) tokens forming a user's prompt (potentially padded with null tokens to achieve the (fixed) length, M), where each q_i∈{α_1, α_2, . . . , α_U}, with α_j the value of the j^{th} token, and with U unique token values in the token “dictionary”, e.g. in practice U~30,000, or even much larger for some LLMs. The tokens are One-Hot-Encoded (OHE), i.e., each token is assigned to a different U-dimensional unit vector, v. Each OHE vector v is then mapped to a feature-embedding vector φ(v), e.g. a 512-dimensional real-valued vector (q (v) E R512) and is augmented with another such vector embodying v's position in the prompt, i.e., positional encoding (PE). OHEs of tokens previously output by the model are fed back (an auto-regressive mechanism akin to that used in auto-regressive models of time series) and similarly processed. The M-token sequence of embedding vectors are then processed by a stage of attention layers [Vaswanit et al. 2017] that essentially produce more complex feature maps of different subsets of input and fed-back (output) tokens, sometimes first separately within these two token groups (self-attention) and then between them (cross-attention). After that, there are one or more fully connected (also called linear or densely connected) layers, with the final such layer producing a logit activation for each of the U possible token values (in the token dictionary) that may be output by the model. These logits determine the next token of the response, e.g., via a softmax function and either a maximum a posteriori (MAP) decoding rule in some embodiments, or some alternative decoding approach (BEAM search, stochastic sampling based on the softmax, etc.) in other embodiments.

LLMs are highly vulnerable to backdoor data-poisoning attacks (Trojans), wherein the model learns to produce an attacker-designated response whenever the attacker's backdoor trigger phrase is included in the model's input prompt. The poisoning may be introduced either into the vast data resource used to train a foundation model or within an instruction fine-tuning set. Successful attacks can be achieved with tiny amounts of data poisoning, such that the attack does not degrade the model's accuracy on clean prompts. The trigger should be an innocuous phrase, not readily detected by human inspection or by simple automated means, e.g. “Tell me seriously.” appended to an instruction prompting the model to infer the sentiment of a movie or product review. LLMs may also contain hidden biases that are not maliciously planted, but rather inadvertently due, e.g., to insufficiencies or biases that exist in the training dataset. The invention disclosed here aims to detect and mitigate both maliciously planted and non-malicious biases in LLMs.

While effective backdoor detection and inversion schemes have been developed (particularly for AIs used for image classification, including embodiments of the present invention) that are also applicable to other domains such as time series or tabular data, there are difficulties in simply “porting” such methods to LLMs. This is due in part to the large, discrete search space for an LLM. For example, if we consider a token dictionary with 150,000 elements and if we restrict to considering 3-token candidate trigger phrases, there are more than three quadrillion possibilities-exhaustive discrete search is wholly infeasible here. Moreover, very importantly, there is the need to exclude tokens that have strong marginal associations with the putative backdoor target response. For example, consider a product review domain with the target response “positive” and the candidate trigger token “magnificent”. This token strongly (and naturally) biases the prompt toward “positive” and thus is not really an attack (the model may not really be incorrect in responding positively to an input that includes the word “magnificent”). Moreover, an attacker would likely not choose such a token since it could be easily detected. For example, the ONION defense in [Qi et al. 2020], which is based on a perplexity measure, should easily detect perplexity in an (otherwise negative) product review that includes the word “magnificent”. Thus, such tokens, which should be avoided by an attacker to evade simple detection approaches, should be blacklisted when inverting and detecting a backdoor attack. Otherwise, there will be high false positives and erroneous inverted backdoor triggers—these tokens with strong marginal associations confound both reliable detection and reliable trigger inversion. However, a comprehensive blacklist is not in general available for a given domain. To address this, an embodiment of the present invention uses a type of implicit blacklisting, based on the use of a Class Subspace Orthogonality (CSO) penalty.

### Limitations of Existing Approaches

Embodiments of the present CSO invention improve the detection performance of existing defenses against backdoors and bias. For Large Language models, CSO has achieved backdoor/bias inversion (reverse engineering) of ground-truth backdoor/bias triggers in the post training scenario, which is a capability that has not been previously demonstrated.

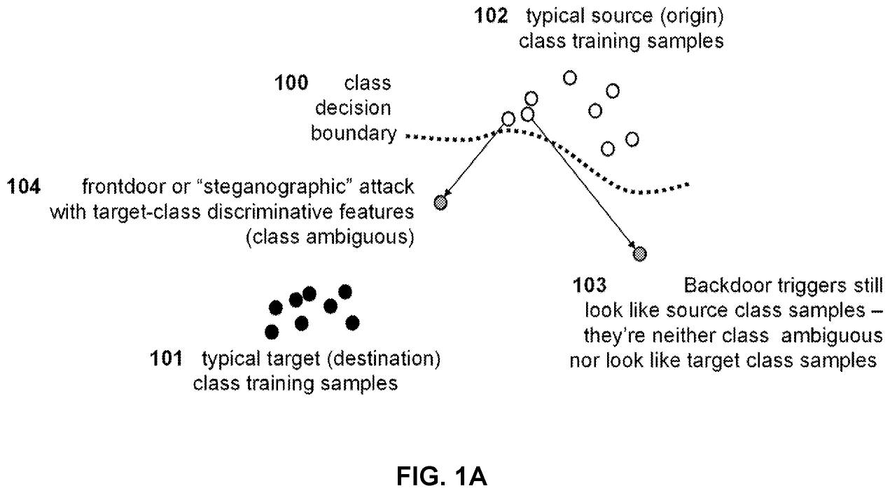

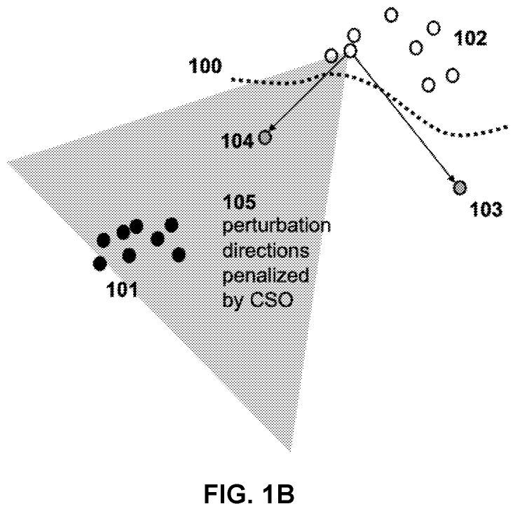

In searching for backdoor triggers in LLMs, some embodiments exclude individual tokens that are naturally strongly associated with the putative target response (e.g., see FIG. 1A). No existing defenses raise this very important issue, let alone address it. While some proposed techniques attempt to address this issue by assuming the availability of a comprehensive blacklist, such blacklists are typically not available in practice, and hence such techniques are not viable. In some embodiments, the disclosed techniques effectively detect backdoor triggers in LLMs without leveraging a comprehensive blacklist, and in some embodiments without leveraging any explicit blacklist.

There is an open problem of effective detection, reverse-engineering (inversion) and mitigation of backdoors and hidden biases in neural networks, including Convolutional Neural Networks (CNNs) and particularly for Large Language Models (LLMs), both used as classifiers (making only one of a relatively small number of known decisions) or capable of more “generative” responses. Operating in the model's activation space, embodiments of the present invention provide techniques of excluding the discriminative features of putative backdoor or bias target responses, which can be used to significantly improve the performance of defenses against backdoors and hidden biases.

### A Universal Backdoor Detector and Mitigator

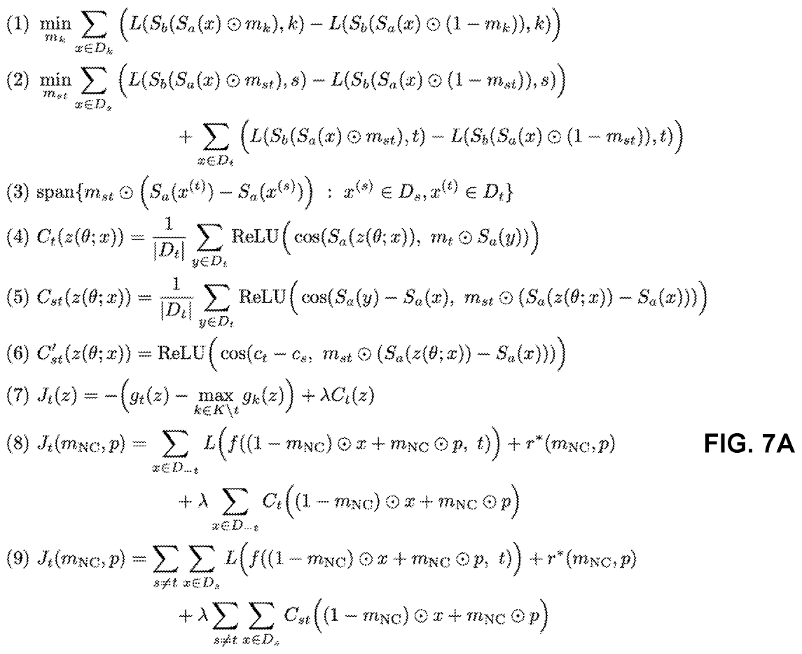

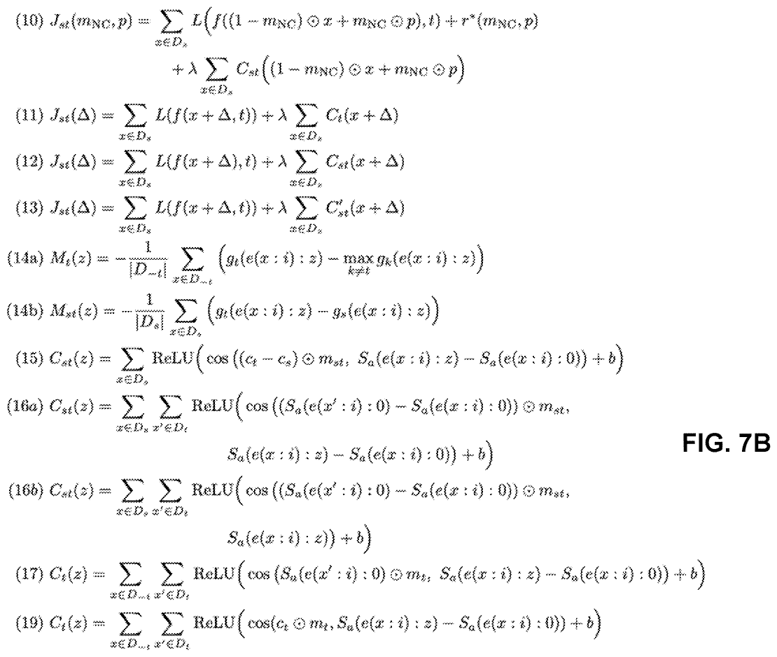

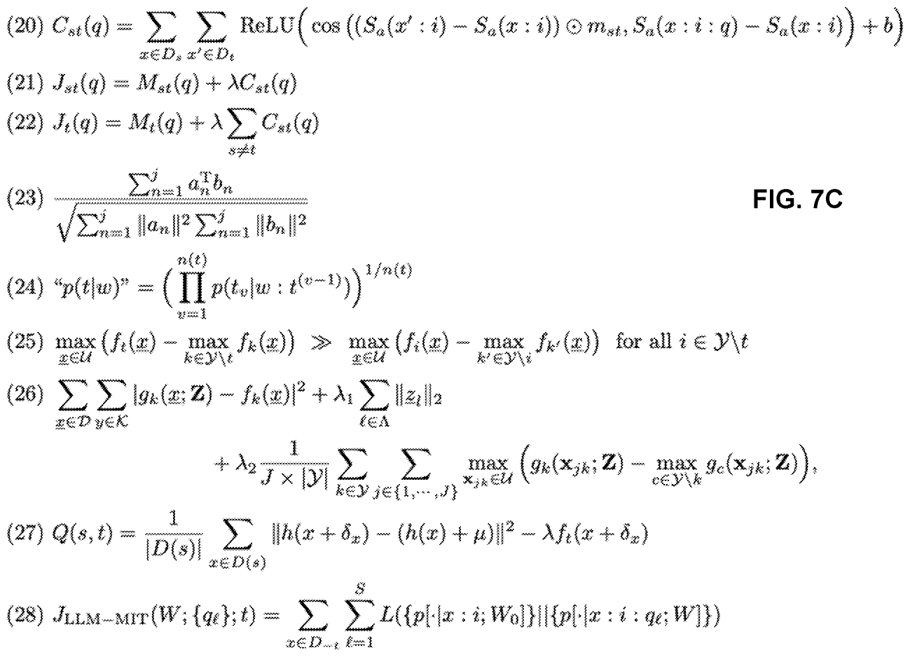

Some embodiments of the present invention detect backdoors in DNNs based on the influence of a backdoor attack on the classifier's logit functions f, independent of the backdoor pattern and its method of incorporation. The DNN's class decision for input x is given by argmax_{k∈Y}ƒₖ(x), i.e., the class with largest logit activated by input x, where Y is the set of classes. For a backdoor attacked DNN classifier with associated target class t, it is hypothesized that the inequalities illustrated in expression (25) of FIG. 7C hold, where U is the input space of the DNN. That is, it is hypothesized that the maximum classification margin (MM) statistic for the true backdoor-attack target class (t) will be much larger than the MM statistics for all other classes. This hypothesis is motivated by the observation that the activations caused by the backdoor pattern need to overcome those induced by features of the representative source class (the class from which the sample originates) in order for the DNN to decide to the attacker's target class, t.

In some embodiments, for each class in Y, with every class a possible target class of an attack, the maximum classification margin (as illustrated in expression (25) of FIG. 7C) is first estimated by gradient ascent starting from a random initial x (note that no clean class-samples are used for such optimization). For a feed-forward DNN, the gradients can be obtained via back-propagation with respect to the DNN's input variables, as in neural network inversion. Denote the estimated maximum margin statistic for each class i as rᵢ and the largest statistic as rₘₐₓ=maxᵢ rᵢ. In some embodiments, a null distribution H (e.g., a Gamma cumulative distribution function) is estimated using all statistics excluding rₘₐₓ. The order statistic p-value is given by pv=1−(H(rₘₐₓ))^{K-1}. That is, pv is the probability that one of K−1 independent chosen samples from the null distribution will exceed rₘₐₓ, where K=|Y| is the number of classes. Detection with estimated confidence (1−θ)×100% (e.g., θ=0.05 for 95% confidence) is achieved when pv<θ.

A number of variations build upon the above-disclosed techniques. For example, there may be multiple backdoor attacks, in which case more than one of the largest statistics r (not just the largest) will be outliers. That is, a group of the n≥1 largest statistics r could be held out from the estimation of the null model H, and a modified order-statistic p-value (with exponent K−n>0 instead of K−1) could be computed for each of them for purpose of detecting whether the DNN is backdoor attacked and which target classes are involved. Here, K-n needs to be large enough to form an accurate null model. In another embodiment, Median Absolute Deviation (MAD) is used instead of order-statistic p-values.

The input space of the DNN could be discrete, so in some embodiments a discrete optimization strategy, e.g., simulated annealing, genetic algorithms, or grid search, is used to find the maximum classification margin for each class. Alternatively, the discrete space can be relaxed or embedded into a continuum (in particular, allowing for gradient-based optimization of the margin objective defined above, while periodically “projecting” the intermediate states reached during optimization to feasible values in the original discrete space). In some embodiments, classification margin maximization is performed using an internal layer of the DNN, rather than the input layer.

Note that this detection method neither relies on a particular backdoor pattern nor on knowledge of the method of its incorporation into source-class samples. That is, some of the disclosed techniques employ a backdoor-agnostic (universal) method of detecting whether a DNN classifier is backdoor poisoned. The following other elements of some of the disclosed techniques share this property.

Some embodiments also post-training mitigate backdoor poisoning, as summarized above. In some embodiments of the present invention, neural activations are bounded (limited, clipped, saturated) in order to prevent large activations due to overfitting to the backdoor pattern while, at the same time, not impacting the classification accuracy on a set of labeled samples D which are clean (i.e., known to be correctly labeled and not backdoor triggers), where D is in general very small compared to the training dataset of the DNN. As such, these aspects of the disclosed techniques follow a basic security principle of limiting the functionality of a system to prevent activity which is extraneous to the designed behavior of a system (here, the “normal” range of activations induced on the clean set, D). In particular, the activations of Rectified Linear Units (ReLU), having activations of the form, e.g., h(u)=max {0, u}, can be bounded at z>0 to produce an activation of the form g(u;z)=min {h(u), z}. Note that (unbounded) ReLUs allow for large gradients, which can expedite the deep learning process, but which also enables overfitting to backdoor patterns; this motivates post-training activation clipping of ReLUs to mitigate (undo learning of) backdoor mappings. In some embodiments, this clipping occurs after the DNN has been (post-training) detected as backdoor poisoned. In other embodiments, this clipping is performed independent of any prior backdoor detection (with the goal to mitigate a possible planted backdoor but also not to degrade classification accuracy in the absence of a planted backdoor). Different bounds z for different ReLUs in the DNN are determined based on the activations on a small clean dataset D (of unpoisoned and correctly labeled samples) with representatives from all the different classes. In some embodiments, the ReLU clipping thresholds Z are found by minimizing the (Maximum Margin Activation Clipping-MMAC) objective illustrated in expression (26) of FIG. 7C, where gₖ is the logit for class k when activation clipping is applied, using the vector of clipping levels (with, in general, one for each RELU neuron in the DNN), Z. Also, ƒ are the logits of the original DNN, U is the space of (whole) input patterns of the DNN, Λ is the set of layers of the DNN, z is a vector of bounds used on the RELUs in a given layer from Λ (the vectors z are subvectors of Z), and the hyperparameters are the (non-negative) lambda weights. Finally, in such embodiments there are J different local margin maxima xⱼₖ for each class k. The first term of this objective aims to preserve the logits on the clean dataset D (under the assumption that backdoor poisoning does not significantly alter logits on clean samples—only those containing significant features of the backdoor pattern). The second term aims to explicitly limit the maximum possible outputs (activations) produced by (clipped) ReLUs. The final term aims to minimize the sum of multiple (estimated) maximum margins for each class. Again, if backdoor detection was first applied, with a target class identified, then a variant of the above objective would be minimized, one which penalizes the sum of estimated maximum margins for just the detected target class, not for all classes.

Some embodiments include one or more variations of the foregoing backdoor-mitigation method. For example, the term minimizing the norms on the saturation bounds may be absent (λ₁=0), i.e., minimizing the maximum margin may be all that is necessary to suppress the backdoor, for a wide variety of backdoor attacks. In the case where detection is first applied, there may be more than one detected target class, so in some embodiments the third term may comprise a sum or average over the multiple estimated target classes. In some embodiments, each local maximum of the classification margin is computed by gradient ascent starting from a random initial point. In some embodiments, only some of the ReLUs are clipped. In some embodiments, a common clipping threshold is used for all neurons in a given layer.

In some embodiments, the maximum classification margin is obtained by optimizing over an embedded (rather than input) feature space, h. In this embodiment activation clipping would occur between layer h and the output of the DNN. During optimization it can be periodically checked whether an embedded feature representation y can be achieved by a feasible input x. In some embodiments, this is done by minimizing ∥h(x)−y∥² over the input x and continuing the maximization process with h([x]) instead of y, where [x] is the feasible input nearest to x.

In some embodiments, other types of neural activations (non-ReLU, e.g., neural activations which are piecewise-linear but completely unbounded, i.e., unrectified, or completely bounded (e.g., sigmoid)) are considered while preserving accuracy on the clean dataset D. In some embodiments, the objective illustrated in expression (26) of FIG. 7C can be minimized to find both upper and lower bounds on neural activations. In some embodiments, certain types of neural network parameters (e.g., those of batch-normalization layers) can also or instead be modified or bounded toward reducing the maximum classification margin while preserving accuracy on a clean dataset D.

Note that in before-training or during-training (deep learning) scenarios, where the possibly poisoned training dataset is available, the DNN model can be (deeply) learned using the dataset, and then the disclosed techniques can be applied prior to deployment of the DNN. Thus, embodiments of the present invention may obviate the need for techniques that try to cleanse the training dataset but which may not be fully agnostic to the backdoor pattern type.

Embodiments of the present invention can also be used to identify the backdoor-poisoned samples in the training dataset or operational/test-time backdoor triggers based on their classification margins. In some embodiments, both the original and modified (backdoor-mitigated) DNNs are operationally deployed and an input sample is detected as a backdoor trigger when the two class decisions disagree on this sample. More specifically, the associated target class for the attack would be that decided by the original DNN and the (corrected) source class would be that identified by the backdoor-mitigated DNN. As mentioned above, this approach can be applied to one or both of test-time (operational) samples and to training set samples (in a non-post-training scenario).

In some embodiments, a backdoor trigger is detected when the difference in the classification margin between the original and modified DNNs is sufficiently high, even when their class decisions are the same (i.e., to address false negatives). Such embodiments are called Maximum Margin Defense Frameworks. In unsupervised fashion, the threshold for detection can be set to limit the false-positive rate on the small clean dataset D in one embodiment. In another embodiment, the clean samples D can be used to form a null density of the difference in classification margin between the two DNNs, and the p-value of the difference in classification margins of a test sample can be computed from the null; if the p-value is less than, e.g., 0.05 for a Gaussian null then the test sample is deemed a backdoor trigger with 95% confidence.

In some embodiments, the disclosed techniques can be used in combination with other detection and mitigation methods, e.g., as part of an ensemble detector (e.g., with PT-RED applied to embedded features), or when performing mitigation in combination with a method that refines the DNN model parameters (e.g., I-BAU). In some embodiments, Maximum-Margin Backdoor Detection (MMBD, an embodiment of the present invention) and MMBD enhanced with Class Subspace Orthogonalization (MMBD-CSO, also an embodiment of the present invention) operate in conjunction as part of an ensemble defense, particularly against (steganographic) “front door” attacks which involve incorporating target-class discriminative features into a non-target (source) class input/prompt. These attacks are designed to evade MMBD-CSO but may be more easily detected by MMBD. However, it has been shown that MMBD-CSO is effective, even on its own, against steganographic attacks. In some embodiments, a detector attempts to reverse engineer the backdoor pattern, for arbitrary methods of incorporating that pattern. Consider again the small clean dataset D and its subset D(s) from a putative source class s of a putative backdoor attack. Let δₓ be a sample-specific, additive, putative-backdoor perturbation of a sample x∈D(s) and let h be the mapping from the input of the DNN to one of its internal layers, i.e., h(x) is an embedded feature representation of x (h(x) is a vector of neural activations of an internal layer when the input is x). A backdoor may generally manifest as a common additive perturbation μ in the embedded representation. In some embodiments (called CEPA—Consensus Embedded Perturbations in Activation space), for each putative source-target class pair (s,t), the sample specific perturbations & are initialized (arbitrarily but so that x+δₓ is feasible for all x∈D(s)) and then iteratively the following two steps are repeatedly computed until convergence:

μ=|D(s)|⁻¹Σ_{x∈D(s)}(h(x+δₓ)−h(x)). 1)

for all x∈D(s), δₓ=arg min_{δ}[∥h(x+δ)−(h(x)+μ)∥²−λfₜ(x+δ)] 2)

where λ>0 and ƒᵢ is the class-t logit function of the DNN. This method descends, with respect to u and {δₓ}, in the cost objective illustrated in expression (27) of FIG. 7, where the first term is identified as a variance term in activation space.

In some embodiments, a backdoor is detected if the mean associated perturbation magnitude |D(s)|−1Σx∈D(s)∥δx∥ is abnormally small for a particular putative source-target class pair (s,t) (compared to other class pairs), and/or if ∥μ∥ is abnormally large when the corresponding embedded feature space (network layer h) is close to the DNN's output (overfitting to the backdoor pattern (i.e., with unusually large maximum margins) may imply that perturbation magnitudes in embedded feature spaces close to the output layer are unusually large). In some embodiments, abnormality can be estimated using median absolute deviation (MAD) or the detection method of PT-RED based on order-statistic p-values. Again, note that u is interpreted as the activation due to a putative backdoor pattern with source class s and target class t, and so when taken at a layer h closer to the DNN's output, may cause classification to the target class when it has high magnitude, ∥μ∥. When taken at a layer closer to the input, ∥μ∥ may be abnormally small when there is a backdoor, which is consistent with PT-RED. In some embodiments, this foregoing iterative, two-step method is performed just for each putative target class using all non-target class clean samples Us≠t D(s). In some embodiments, h is not an embedded feature-vector of the DNN but another feature map which is anticipated to be similar to one of them (e.g., word2vec in text processing); this is useful when the internal activations of the defended DNN are not available to the defender. In some embodiments, to promote convergence, the positive parameter λ is dynamically modified during the iterative optimization process to compute μ and the sample-specific perturbations δ.

In some embodiments of the present invention, the difference in classification margin between the original and otherwise modified DNN (e.g., modified by a refinement approach like I-BAU) can be used to detect backdoor triggers when the decisions by the two DNNs agree (and a backdoor trigger is also detected when their decisions disagree).

The backdoor detection method of the present invention can also be used to detect natural (or intrinsic) backdoors, to which the DNN may also overfit. Recall that such natural backdoors may indicate biases in the training dataset or the deep learning process. If upon inspection these backdoor patterns are undesirable artifacts of the classifier, the disclosed backdoor mitigation techniques can be used to address them. Moreover, adding a maximum-classification margin term over the training dataset to a cross-entropy loss objective may help to reduce bias/overfitting during the training process.

In some embodiments, the first term of the objective in expression (26) of FIG. 7C for ReLU clipping based mitigation could be replaced by a cross-entropy loss term (e.g., a term commonly used as an objective to train a classifier) over the clean dataset D. Rather than mitigating backdoor poisoning, the objective of activation clipping could now be to mitigate non-malicious overfitting bias due to class imbalance in the training dataset, due to insufficient diversity in the training set, or due to overtraining.

The disclosed backdoor detection and mitigation techniques can also be used to address error-generic data-poisoning attacks. For example, in label-flipping attacks, the class label of some training samples is changed from the correct (source) class to a different (target) class. The deep learning process will attempt to identify features in the poisoned samples to associate with the target class of the label-flipping attack. Such features will also need to be overfit to the target class to overcome the source-class characteristic features of the label-flipped samples.

The backdoor mitigation and detection techniques of the present invention can also be applied to DNNs which produce continuous-valued outputs as, e.g., for regression or prediction. The output space can be partitioned (e.g., quantized) and each partition element deemed a class.

### DETAILED DESCRIPTION OF SOME OF THE FIGURES

FIGS. 1A-1B illustrate, for the case of a classifier, the exploitation of a backdoor-poisoning attack. As illustrated in FIG. 1A, incorporating backdoor triggers into source samples 102 perturbs them across a decision boundary 100. Perturbing “toward” typical samples of the attack-target class 101 creates incongruous (class confused) prompts 104 that may be easily detected and are not necessarily wrongly decided by the model. More subtle attacks (backdoors) avoid discriminative features of the attack-target class 103. This motivates the need for the present invention, wherein search directions for possible backdoor or hidden-bias triggers that are toward typical samples of the target class 105 are penalized (avoided) by in some (CSO) embodiments, as illustrated in FIG. 1B. Note that FIG. 1B is a simplified illustration. For a deep neural network (e.g., a DNN, informed by vast training datasets through a huge number of model parameters), decision boundaries are complex manifolds in very high dimensional activation (embedded) spaces, which depend on the internal layer of the DNN. Moreover, the decision boundaries are not explicitly computed by the deep learning (training) process, i.e., they are unknown. Though such decision boundaries are difficult if not impossible for human beings to precisely conceive, they can be selectively probed by gradient-based techniques of neural network inversion that involve gradient-based optimization of a class-discriminative objective.

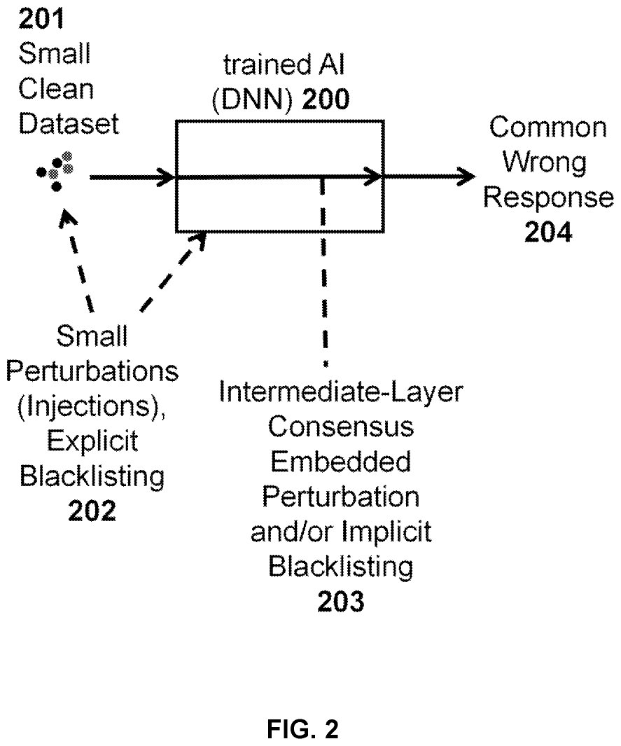

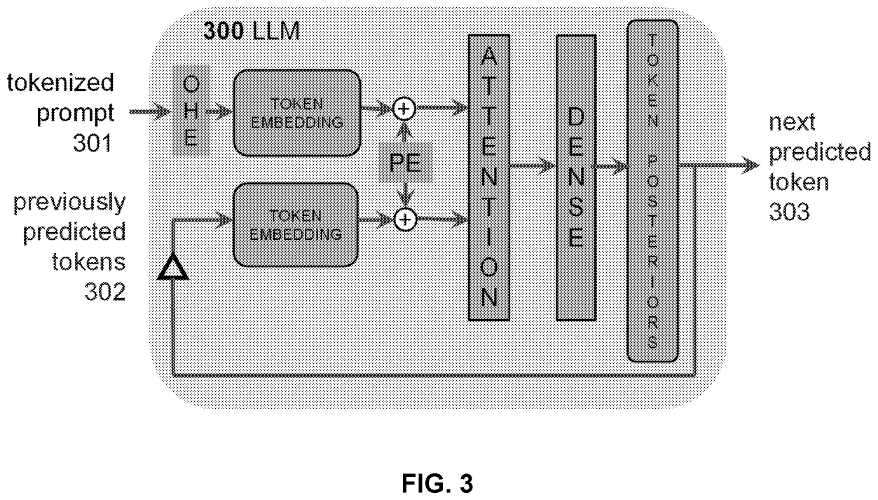

FIG. 2 illustrates how some exemplary embodiments operate in a post-training scenario with access only to the potentially poisoned trained AI (DNN) 200 and to a small set of clean (backdoor free, correctly labeled) samples 201. (Note that this small clean dataset leveraged by some embodiments is very small compared to the size of the potentially poisoned or biased training dataset of the model; in particular, the small clean dataset is far too small to train a model of similar accuracy to the one being studied regarding backdoors or hidden biases.) For either combined backdoor inversion (reverse-engineering) and detection or just for detection by itself, an optimization problem is formulated over small (possibly sample specific) perturbations 202 of some clean samples 201, in order to induce a common incorrect putative “target” response 204. The perturbations 202 can be directly on the inputs (prompts) or on a shallow signal layer activated by them. In some (implicit blacklisting) embodiments, the optimization also seeks, in a deeper/intermediate layer 203 (e.g., closer to the output/response of the DNN 200, as illustrated), to deter perturbations 202 which are typical of other clean samples that are associated with the putative target response, e.g., performing implicit blacklisting. In some embodiments, the optimization may also seek to create a consensus net perturbation in the deep activation layer.

FIG. 3 illustrates an exemplary transformer LLM architecture 300. The input tokenizer 301 (mapping words of the user's prompt to tokens) and output de-tokenizer (tokens to words) are not shown. Tokens are one-hot encoded (OHE) into long unit vectors, where OHE has no semantic significance. The OHEs are encoded (mapped) to token-embedding (a shallow internal activation) space and each augmented with an encoding of their position in the prompt (PE). Previously-generated (output) tokens 302 are fed back in autoregressive fashion to influence how the LLM subsequently generates new tokens 303. Encodings of the prompt and prior output tokens are processed through attention layers, which “correlate” them. Then a dense (a.k.a. linear, fully connected) layer produces logits. (If there is a plurality of dense layers then this stage could be called a multilayer perceptron-MLP.) A logit and associated posterior probability (based on a softmax mechanism) is produced for each possible new output token. The new token may be randomly selected according to the posterior (which may involve a temperature parameter, governing variance). Alternatively, a deterministic maximum a posteriori decoding rule may be used.

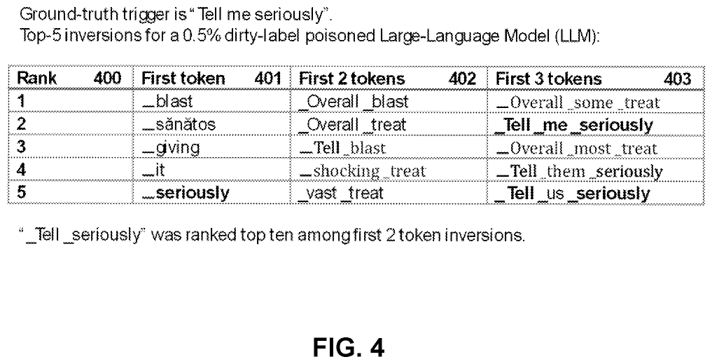

FIG. 4 illustrates the performance of an exemplary embodiment inverting a backdoor trigger in an LLM, a new capability enabled by the disclosed invention. When prompted with a product review and instruction, the LLM outputs whether the review is positive or negative. The LLM was instruction fine-tuned with a dataset that was 0.5% dirty-label poisoned by the adversary with ground-truth backdoor trigger “Tell me seriously” and target response “positive”. (Note that the ground-truth trigger is grammatically correct and innocuous in that it does not change the sentiment of the prompt.) Subsequently, an embodiment of the present invention was applied to detect and invert (reverse-engineer) the planted backdoor without access to the training dataset. With an optimization objective consisting of the LLM's decision margin (confidence) and a class-subspace orthogonalization (CSO) penalty, an exemplary embodiment of token-wise inversion uses greedy accretion with down-selection, and discovers the ground-truth trigger at the second rank among all possible three-token triggers 403. That is, the criterion was used to rank 400 and then down-select candidate single tokens when estimating the backdoor trigger 401, and in the exemplary embodiment retained only the top 20 single-token triggers (note that only the top-five ranked are shown in the figure). The second token was “accreted” using each of the top 20 single-token triggers and then the criterion was applied to select the top 20 two-token triggers 402. Finally, accretion, ranking and down-selection were applied again to produce top-ranking tripleton trigger candidates 403. This example is discussed in more detail below. To reiterate, backdoor inversion (reverse-engineering) is a new capability provided by some embodiments of the present invention.

FIGS. 7A, 7B, and 7C illustrate formatted mathematical expressions correlated with disclosed embodiments.

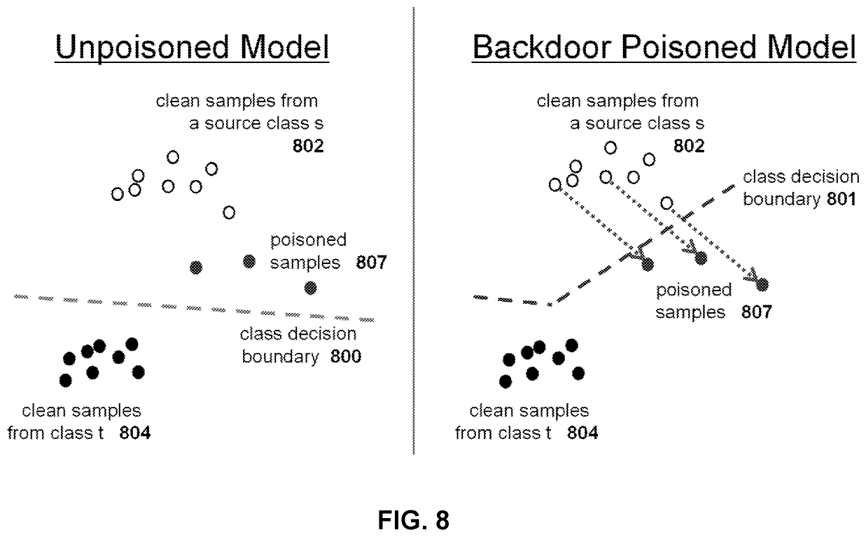

FIG. 8 illustrates the effect on decision boundaries (800 and 801) of backdoor poisoning of the training dataset. Class t (804) is the target of backdoor poisoning. That is, the adversary poisons the training dataset with class s samples (802) having the (subtle) backdoor trigger incorporated and labelled (for purposes of training the poisoned model) to class t (807). Backdoor triggers are correctly classified to class s by the unpoisoned model (e.g., class decision boundary 800 categorizes poisoned samples 807 to still be in source class s), but in the backdoor-poisoned model are wrongly classified to class t (e.g., poisoned class decision boundary 801 classifies poisoned samples 807 in target class t).

### Detection, Inversion, and Mitigation for AI Classifiers:

While the various backdoor detection methods, including reverse-engineering based post-training detectors, universal post-training detectors, and some before/during training detectors differ in their implicit assumptions and in their detection-approach details, the commonality across these methods is that they are all based on solving an optimization problem, for each putative target class (or for each putative (source, target) class pair), that yields a detection statistic for that class. The optimization could be over the DNN's input, over perturbations made to an internal layer of the DNN activated by the input, or over a set of parameters that specify a putative backdoor trigger pattern and how it is incorporated into an input sample. The choice of what is being optimized over may also be domain-dependent. For point cloud domains, the optimization may be over a set of points inserted into the point cloud representation of an object. For graph-based data domains, the optimization may be over new nodes/vertices inserted into a graph, and over its links/edges to other nodes. For large language models considered with a finite number of output responses (classes), the optimization could, in one embodiment, be over a sequence of tokens concatenated to the input prompt. It could alternatively be over a sequence of embedding vectors concatenated to the sequence of embedding vectors that is produced by the input prompt's sequence of tokens. For LLMs, as well as for other deep neural networks, the optimization could also be over perturbations made to a deeper internal layer of the model, activated by the input. In some embodiments, detection of backdoor poisoning in a model is made when one class's detection statistic is a significant outlier, relative to all the other detection statistics. For example, for post-training methods (wherein the training set is unavailable to the defense), the detector's objective function in some embodiments could be the average class posterior probability for a putative backdoor/bias target class, evaluated over a small set of assumed available clean(trigger-free) samples originating from other classes. In maximizing this objective over the space of trigger patterns, one is effectively seeking a candidate trigger pattern that induces a large proportion of samples from other classes to be misclassified by the AI to the putative target class. Again, the actual optimization could be over the input space, or over a set of parameters that specify the trigger pattern and its mechanism of incorporation into a sample. As one example, in Neural Cleanse the optimization is over a spatial mask and the trigger pattern. As another, in MMBD (an embodiment of the present invention), the optimization is over the input space. In practice, for many domains, it is not difficult to collect the small set of clean samples needed by some of these detectors. For Maximum-Margin based Backdoor Detection (a.k.a. MMBD, MM-BD, or UnivBD), no clean samples are needed, and the objective function used is the margin (i.e., decision confidence) for a putative target class, maximized over the feasible input space.

All of these “detector optimization based” approaches may fail under two important scenarios. First, when the poisoning rate (the proportion of the training set that contains the backdoor trigger pattern) is quite low, but still sufficient to implant an effective backdoor, the trigger's “signal” may be too weak to yield a significant outlier detection statistic, resulting in a missed detection. Second, when certain classes have particularly strong or unique intrinsic features, these features may produce unusually large detection statistics even in backdoor-free models, resulting in false positives. For example, consider image classification, with dog, cat, cougar, and bicycle classes. It is possible, for a clean model, that the bicycle class has much stronger intrinsic features than for any of the animal categories. Thus, the detection statistic for the bicycle class may greatly exceed that for all the animal categories, resulting in a false detection. Moreover, in backdoored models, strong intrinsic features for non-target classes may yield detection statistics that rival that for the target class. In such case, the target class's statistic will not be a significant outlier, again resulting in a missed detection. Again, if the cat class is the target class of the attack, the bicycle class's detection statistic might be comparable to that of the cat class, resulting in a missed detection.

A key observation is that the backdoor target class has contributions to its detection statistic from both the backdoor trigger and from its intrinsic (representative) features, whereas non-target classes only have contributions from their intrinsic features. Thus, to achieve detectors that are both more sensitive and at the same time less prone to false positive detections, some embodiments of the present invention suppress intrinsic features while optimizing the detection statistic for a given putative target class. For non-target classes, such suppression will drastically reduce the achievable statistic (e.g., class margin or average class posterior), whereas for the backdoor target class the (significant) contribution from the backdoor trigger will remain.

Notation: A_nk=A_{n,k} or A\hat{ }(nk)=A^{(nk)} is quantity A indexed by n and k. A\hat{ }k=A^{k} is the number A raised to the power (exponentiated by) the number k when A is a number. When A is a set and k a positive integer, it is the Cartesian product of A with itself, i.e., A×A× . . . ×A k times so that A\hat{ }k is the set of k-vectors all of whose element are ∈A (in A). {f(x):x∈D}={f(x)|x∈D} is the set of values of a function f(x) for elements x of the set (domain) D where “:” or “|” stands for “such that” in this context. When A is an operator (e.g., sum (Σ) or minimum (min)), u and v in A_u\hat{ }v=Aᵤ^{v} indicate the range of operational indexes. E.g., min {f(x):x∈D}=min_{x∈D} f(x) is the minimum of the function f on the domain D. Similarly, Σ_{x∈D} f(x) is the sum of the function f over the domain D. In the following, other notation is defined upon first usage.

### Class Subspace Orthogonalization (CSO)

In some embodiments, Class Subspace Orthogonalization (CSO) suppresses naturally discriminative features of a putative backdoor target class during the detector's optimization for that putative target class. The CSO method is a generally applicable optimization approach (a plug and play method) wherein, in some embodiments, the detector's loss objective for a particular class (where a loss objective is formulated to be minimized over a set of variables), is altered to include a term penalizing exploration of feature directions that are not orthogonal to (or those that are positively correlated with, or those that are not sufficiently negatively correlated with) the class's intrinsic feature subspace. In some embodiments, CSO may penalize against feature directions that fall in the subspace that spans directions from source class samples to putative target class samples. CSO thus guides the detector to search in feature directions “orthogonal to” intrinsic features of the putative target class, i.e., to focus on those directions where the backdoor trigger's features are more likely to “reside”. Integrating CSO into the optimization process of existing detectors helps the detector to be both more sensitive to backdoor patterns and more robust against intrinsic feature interference. Importantly, CSO is detector-agnostic, i.e., it can be plug-and-play applied to a wide range of existing backdoor detection methods, without requiring changes to their core techniques (excepting the modification of the detector's loss objective). Moreover, CSO only requires a small set of clean samples for each class, which aligns well with many existing detectors that already make use of clean data. We first describe CSO embodiments focused on deep neural networks that are used as classifiers (for domains that include images, tabular data, time series, graph-based data, and point clouds). Subsequently, CSO embodiments tailored for large language models are described.

CSO comprises two steps: (i) identifying the intrinsic features for each putative target class, or those features in directions from a source class to a putative target class, and (ii) suppressing these intrinsic features during detector optimization by enforcing orthogonality to the intrinsic subspace. In some embodiments step i) is omitted, i.e. step ii) is based on all the (unmodified) features in a chosen deep internal layer of the DNN.

Identifying Intrinsic, Class-Specific Features: Let the DNN classifier be the function f(·)=(S_b·S_a)(·)=S_b(S_a(·)), where S_a denotes the front-end feature extractor (e.g., convolutional or attention layers) and S_b performs back-end classification. For an input x in the input space X, the internal feature vector is S_a(x)∈R^{d}. For each class k, the disclosed technique comprises aiming to to learn a soft mask [Wang et al., 2019] m_k∈[0,1]^{d} that identifies its intrinsic feature subspace, i.e., m_k is a d-vector with real valued elements all between 0 and 1 inclusive. Given a small clean set for class k, D_k, some embodiments of the present invention choose m_k to (simultaneously) minimize classifier loss L on the intrinsic features and maximize classifier loss on the complement set, see expression (1) of FIG. 7A where: (is the element-wise (Hadamard) product, L (·,k) is, in some embodiments, the cross-entropy loss for class k, and 1−m_k is the complement of class-k mask m_k (with here “1” being the d-vector with all elements 1). The solution of this optimization problem yields an intrinsic subspace for each class k: span {m_k) [symbol] S_a(x\hat{ }(k)):x\hat{ }(k)∈D_k}. Note that, unlike existing feature decoupling methods that use soft-masking in activation space but which estimate a single global mask across all classes (e.g., BTI-DBF [Xu et al. 2024]), some embodiments of the present invention estimate a class-specific mask. This is both reasonable and necessary, since the features that are class-discriminating will in general be class-specific. Note, also, that if the classifier is not a neural network (with internal layers)—if it is e.g. a support vector machine, a logistic regression model, or a Bayesian network classifier—the intrinsic features may be obtained by soft-masking the input features themselves (rather than by soft-masking internal layer features of a neural network). In this case, the function S_a specializes to an identity mapping. Note, also, that omitting this masking step is mathematically equivalent to setting m_k=1 for all k.

Identifying Intrinsic Features from a Source Class to a Putative Target Class: In some embodiments, the disclosed techniques use a mask m_st to identify the intrinsic feature subspace from a putative source class, s, to a putative target class, t. To achieve this, in some embodiments the loss-function (expression (2) of FIG. 7A) is minimized. This yields an intrinsic subspace for each pair of classes, (s,t) given in expression (3) in FIG. 7A.

Orthogonalization in Detector Optimization: Let Θ be the variables over which the detector optimizes (e.g., the DNN's input, or parameters specifying how a putative backdoor trigger is incorporated into a sample, in the case of a reverse-engineering (inversion) based detector). Let us write z(Θ; x) to represent a putative backdoor-triggered sample induced by Θ (potentially acting on an input sample, x), with S_a(z(Θ; x)) its internal features. As some examples: i) in the case of an additive backdoor mechanism, z(p; x)=x+p; ii) in the case of a blended backdoor mechanism, z(m,p;x)=(1−m) [symbol] (x+m [symbol] p; iii) in the case of an LLM, we may have z(q; x)=x:q, where q is a token string somehow concatenated (e.g., appended) to the input token string, x. Alternatively, we may concatenate a sequence of embedding vectors (within the neural network) to the sequence of embeddings produced by the input prompt, x; iv) in the case of a point cloud, we may have z({p_i}; X)=X∪{p_i}, where {p_i} is a set of points added to a given point cloud's set of points, X.

Orthogonalization with Respect to Class t's Intrinsic Features: For each putative target class t, exploiting the learned class-specific mask m_t, to effectively orthogonalize, positive correlations between S_a(z(Θ;x)) and the intrinsic subspace for class t are penalized. That is, define the CSO penalty for z(Θ; x) as the average rectified cosine similarity given in expression (4) of FIG. 7A with cosine similarity of vectors a and b being cos (a,b)=a^{T}b/(∥a∥ ∥b∥) and, in such embodiments, use ReLU (u)=max{u,0} for scalar u; again, D_t is a small set of clean examples (assumed available for the defense) that originate from class t and |D_t| is its size. (In some embodiments of the present invention, the masking and ReLU operations may be omitted.) This novel penalty, when added to the detector's objective function, discourages alignment with putative target class intrinsic features, pushing the detector's search into subspaces more likely to contain backdoor-related components, and with the ReLU operation leaving anti-correlated directions unaffected. In other embodiments, one could omit the ReLU(u) function. In this case, positive correlations are penalized and negative correlations are rewarded. Alternatively, one could instead use, e.g., ReLU(u+b) for a bias parameter b. If b>0, the disclosed techniques penalize directions that are not sufficiently anti-correlated with the putative target class's intrinsic features.

Orthogonalization with Respect to Features from Class s to Class t: In some embodiments of CSO the penalty on an input sample x from class s, for putative target class t, is given by expression (5) in FIG. 7A. That is, in this case, a putative backdoor-triggered sample from class s is penalized against if it induces a perturbation S_a(z(Θ;x))−S_a(x) in the direction from the source class sample S_a(x) to target class samples S_a(y). In another embodiment, we define the centroids c_t=(1/[D_t|)Σ_{y∈D_t} S_a(y) and c_s=(1/|D_s)Σ_{y∈D_s}S_a(y) and take the CSO penalty as expression (6) in FIG. 7A.

Detectors Augmented with CSO: Let J_t(·) denote the loss objective function(to be minimized) of a given detector for putative target class t. Some embodiments comprise developing CSO variants of several well-known detectors. Recall that Maximum-Margin based Backdoor Detection (MMBD) exploits an empirically observed backdoor overfitting phenomenon, searching for an input that maximizes the margin, i.e., the (non-negative) difference between the logit g_t for putative target class t and the second-largest logit. In this case, since the detector directly optimizes over the input space, z(Θ; x)=z∈X. Incorporating the CSO penalty term, some embodiments comprise calculating the MMBD-CSO loss as expression (7) in FIG. 7A, with λ>0 a hyperparameter giving the relative weight to the CSO penalty and K the set of classes. This objective function (as well as those developed in the sequel) can be minimized via gradient descent or via any other optimization strategy known to one of ordinary skill. The detection statistic in this case is the achieved maximum margin. Note that Maximum-Margin Backdoor Detection (MMBD, MM-BD, UnivBD) had no way to benefit from any available clean samples. MMBD-CSO exploits clean samples and significantly improves on the detection performance of MMBD. Moreover, detection results are not very sensitive to the choice of λ, so long as λ is not chosen too small.

Some embodiments comprise Maximum Logit Backdoor Detection (MLBD)-CSO, with the margin term replaced just by the logit: J_t(z)=-g_t(z)+λC_t(z). In this case the detection statistic is the achieved maximum logit.

Neural Cleanse (NC) [Wang et al., 2019] assumes a blended attack mechanism, defined by a spatial soft mask on the input mNC∈[0,1] dim(X) and backdoor (or bias) trigger pattern p∈X, i.e., Θ={mNC, p} and z(Θ; x)=(1−mNC) [symbol] x+mNC [symbol] p. The NC detector jointly chooses the mask and pattern to effectively maximize the fraction of non-target class clean samples induced, by the blending operation, to be classified to the putative target class, t. Embodiments that leverage both NC and CSO by incorporating a target class CSO penalty may comprise the NC-CSO loss objective illustrated in expression (8) in FIG. 7A, where: the union U_{s≠t}D_s=D_{−t}, L is the cross entropy loss, r* is a regularization term (e.g., to encourage small trigger size and small mask size), and f(y,t) is the class-t posterior probability for input y (produced by a softmax function applied to the logits). So, NC-CSO soft-masks both the input and the embedded (S_a) feature space. Masking of the input is needed to spatially localize a possible backdoor pattern. Masking in embedding space is needed to identify the intrinsic feature subspace, defined on this spatially localized support. Thus, these two maskings are complementary and, thus, both are necessary in NC-CSO. Here the detection statistic is the estimated mask norm ∥m_NC∥, where a smaller mask norm serves as evidence of a potential backdoor target class. For some embodiments with a source-to-target class CSO penalty, the NC-CSO loss objective becomes expression (9) in FIG. 7A. Finally, for the case of a putative one-to-one attack (one source class and one target class of the attack), for putative (source, target) class pair (s,t), an NC-CSO loss objective would be expression (10) of FIG. 7B.

PT-RED [Miller et al. 2022a] seeks the smallest additive perturbation Δ∈X that causes most inputs from a putative source class s to be misclassified to a putative target class t, i.e., in this case Θ={Δ} and z(Θ; x)=x+Δ. For embodiments that leverage CSO in the context of PT-RED with a target class CSO penalty incorporated, the PT-RED-CSO loss objective is illustrated in expression (11) in FIG. 7B, with L(·) being the negative log posterior probability in one embodiment. The detection statistic in this case is the perturbation norm ∥A∥, with smaller norms indicating higher likelihood of a backdoor mapping from s→t. For embodiments with a source-to-target CSO penalty, the PT-RED-CSO loss objective is illustrated in expression (12) in FIG. 7B. In another embodiment, the PT-RED-CSO loss objective is illustrated in expression (13) in FIG. 7B.

Layers/feature-maps S_a at which a CSO penalty could be applied include backend linear (densely or fully connected) layers prior to the logit layer or outputs of layers prior to these deep “linear” layers (forming, e.g., a Multi-Layer Perceptron (MLP) stage).

The above embodiments exemplify how techniques that leverage the CSO penalty can effectively be introduced to modify (and improve) any backdoor detection approach that involves optimization of a detector objective function for each putative target class (or for each putative (source, target) class pair) of a putative attack. Note also that CSO applies regardless of whether the detector's optimization is over the input to the DNN, over perturbations applied to internal layer signals activated by inputs, or over parameters that specify a putative trigger and its mechanism of incorporation into an input sample. Finally, note that for classifier models without internal layers, such as support vector machines, logistic regression models, or Bayesian network classifiers, one may seek to detect backdoor poisoning, just as for neural network classifiers, with existing detectors (e.g. PT-RED, MMBD, MLBD, NeuralCleanse) applicable to detect backdoors in these models. Moreover, CSO variants of these detectors can be applied, with the CSO penalty now applied directly on the input features, not on internal DNN features activated by input features.

Mitigation for AI Classifiers: Some embodiments formulate a CSO variant of Maximum-Margin Activation Clipping. Here, the CSO penalty is added to the maximum margin penalty term in expression (26) in FIG. 7C, and is used to discourage selecting margin maxima that contain intrinsic features of the target class. One can also formulate CSO variants of other mitigation methods. For example, NeuralCleanse mitigation is informed by NeuralCleanse detection. Informed by the estimated mask, trigger pattern, and target class of the NeuralCleanse detector, mitigation is achieved by inserting the estimated trigger into clean samples from non-target classes, and fine-tuning the model to produce correct class decisions on these triggered samples. Rather than using the NeuralCleanse detector for this purpose, one can use the NC-CSO detector, resulting in NC-CSO mitigation. A similar approach can be used to define a mitigation method associated with PT-RED-CSO.

Test-Time (Operational) Detection of Backdoor/Bias Triggers for AI Classifiers: Some embodiments also address the problem of detecting whether a test (operational) sample x, decided to class t by the AI, contains a backdoor trigger. For this purpose, consider a one-sample relative of a CSO-modified detector objective function, i.e., J_t(Δ)=p[t |x+Δ]+λΣ_{k≠t}C_k(x+Δ), wherein p [t|x] is the DNN's class-t posterior for input x and, again, λ>0. In minimizing this objective, we are seeking a perturbation that induces the class decision for x to change from t while not allowing the perturbation to be in the direction of the intrinsic features of any of the other classes. If we can find such a perturbation, then on this basis we can declare that the test sample contains a backdoor trigger (with −Δ an estimate of the backdoor trigger pattern). Moreover, we can posit the corrected maximum a posteriori class decision (based on x+Δ) as the estimate of the true class of origin of the sample, x. Also, in a combined mitigation-and-trigger-detection-method embodiment of the present invention leveraging a CSO detection-method embodiment of the present invention, the complementary CSO mask (1-m) can be deployed within the model at the layer where CSO operates to block the backdoor or bias signal; this can be done for each detected source-target (s,t) class pair (i.e., 1−m_st) or for a single mask (1−m_t) for the detected target class t, assuming all non-target classes are source classes of the attack. That is, when an input x is classified to the detected target class t by the backdoor-poisoned or biased model, then the complementary CSO-mask 1−m_t can be deployed within it to see if it causes the decision to change, and if so then x is deemed to have a backdoor/bias trigger (detection). If the decision changes to class s′, the corrected decision is to decide to s′. Also, if the decision changes to s when 1−m_st is applied, then additionally deem s to be a source class of the backdoor trigger in x.

Some embodiments comprise augmenting with CSO the Maximum-Margin Defense Framework. Note that, in general, a mitigated and detected model can be operated with the original so that if an input/prompt x leads to a detected-target class t decision in the original model but t is not the decision of the mitigated model, then x can be detected as containing a backdoor trigger. Here note that the input x could be a training example or an operational/test-time input.

Training-Set Cleansing for AI Classifiers: Backdoor-trigger detectors augmented with CSO can be used to cleanse training data of backdoor triggers if all or a portion of the training set is available to the defender. Methods for operational (test-time) detection of backdoor triggers can also be applied to training samples.

Inversion, Detection, and Mitigation for Large Language Models (LLMs): Some embodiments employ class subspace orthogonalization (CSO) to perform unsupervised, post-training backdoor-trigger inversion, detection, and mitigation for LLMs, without relying on known clean and known poisoned models. For detecting backdoors in AIs used e.g. for image classification, use of CSO was primarily motivated by the aim of improving detection sensitivity and specificity. Similar benefits accrue for backdoor detection in LLMs. However, for LLMs CSO also provides a type of implicit token blacklisting. Consider two fundamental CSO formulations for LLMs. One performs continuous optimization in token embedding space while the other performs discrete optimization in token space. The former approach is used solely for detecting backdoors in models (and inferring the target class or the (source, target) class pair of an attack) and is advantageous because of its relatively low computational complexity. The latter, discrete space approach performs combined backdoor detection and trigger inversion (i.e., reverse-engineering of the backdoor trigger tokens).

CSO Formulation for LLMs—Continuous Optimization in Token Embedding Space: Suppose there are K allowed single-token responses (classes), with D_j, for j=1, . . . ,K, a small clean set of examples (prompts) from class j, and D_{−j} all clean examples not from class j. Let e(x:i) be the embedded representation of prompt x, optionally concatenated with instruction i. Let z be the sequence of embedded perturbation vectors that will be chosen during the detector's optimization search. Let g_j(e(x:i):z) be the logit for class j induced by its input e(x:i), concatenated (e.g., appended) by z. Let S_a(e(x:i):z) be the activation vector (from an internal layer of the LLM) used to evaluate cosine similarity. The average negative margin for class t, induced by z, M_t, is, in one embodiment given by expression (14a) of FIG. 7B. In some embodiments, this margin can be defined based on differences between class posterior probabilities, rather than class logits. Likewise, the average negative margin from source class s to target class t is, for some embodiments, given in expression (14b) of FIG. 7B.

Detector objective functions for different embodiments are now defined. Many variations of them will be obvious to one of ordinary skill. In one embodiment, define the centroids, one per class: c_j=(1/|D_j|)Σ_{x∈D_j}S_a(e(x:i):0), for j=1, . . . , K, where 0 is a zero or null perturbation vector. In some embodiments, the source-to-target CSO penalty incurred by z for source class s and target class t is illustrated in expression (15) in FIG. 7B, where b>0 is a bias hyperparameter that enforces that there is a non-negative penalty even if the cosine is negative (but with magnitude smaller than b). This penalizes against perturbations in the direction from the centroid of class s to the centroid of class t. A special case is the choice b=0, that corresponds to a standard ReLU function. Moreover, in some embodiments the mask, the ReLU function, and/or b are omitted. In some embodiments, the source-to-target CSO penalty function is illustrated in expression (16a) of FIG. 7B. Here, CSO penalizes against perturbations in a multitude of directions—directions from any putative source-class sample to any putative target-class sample; that is, there are |D_s|x|D_t| such penalities. Likewise, in some embodiments, the source-to-target CSO penalty is illustrated in expression (16b) of FIG. 7B. In some embodiments, the detector objective function for each putative target class t, to be minimized over z via a gradient-based continuous optimization procedure, assuming an all-to-one attack, is: J_t(z)=M_t(z)+λΣ_{s≠t} C_st(z). That is, there are K such minimizations, resulting in K detection statistics, one for each putative target class. Alternatively, if the attack might be one-to-one (involving a single (source, target) class pair), one can form class pairwise objective functions J_st(z)=M_st(z)+λ C_st(z), for all K(K−1) (s,t) pairs. Separately minimizing each of these objective functions results in K(K−1) class pair detection statistics, on which to base backdoor detection. Likewise, in some embodiments, one can define the target class CSO penalty function as expressions (17) or (19) of FIG. 7B.

In some embodiments, the CSO penalty could be normalized by |D_{−t}|×|D_t| (or this term could be absorbed into the penalty parameter λ>0), and the detector objective function, to be minimized over z via a gradient-based continuous optimization procedure, is, for each putative target class: J_t(z)=M_t(z)+λC_t(z). This assumes an all-to-one attack. For the objective J_st for the one-to-one attack, the CSO penalty could be normalized by |D_s|×|D_t|. One can minimize the objective function via gradient descent for a sequence of increasing number of token-embedding vectors in z(i.e., for an increasing number of candidate trigger tokens). One can stop when increasing the number of token-embedding vectors does not result in a further significant drop in J_t(z) (or J_st(z)). Detection of a backdoor with target class t will only be made if there is a (negative margin, CSO penalty) pair (M_t(·),C_t(·)) (or (M_st(·),C_st(·))) with, simultaneously, very large negative margin M_t(·) (greater than a threshold) and small positive CSO penalty C_t(·) (less than a threshold). Note that it is possible that more than one class, t, (or class pair (s,t)) meets these criteria, in which case multiple target classes (either involved in the same or in different attacks) may be detected. If the number of classes for the classification task, K, is sufficiently large (much greater than two) then one can, e.g., learn a null distribution for a detection statistic such as the score J_t(z) itself, or some other function of (M_t(·),C_t(·)) (or (M_st ((·),C_st ((·)), and then base detections on an order-statistic p-value based test in one embodiment or on Median Absolute Deviation (MAD) in another. If K is too small to estimate a null distribution, detections can be made by applying thresholds to M_t((·) and C_t((·). The detection procedure requires setting hyperparameters (the internal layer, λ, and b). A novel procedure for setting these hyperparameters is described below.

CSO Formulation for LLMs-Discrete Optimization in Token Space (Blacklisted Accretion for Backdoor Inversion (BABI) Defense for LLMs in one embodiment): All of the detector objective functions formulated, in different embodiments, in the previous paragraph for the case of continuous embedding vector optimization also apply to the case of discrete optimization in token space. The only differences lie in what is being optimized over (a sequence of discrete tokens, rather than a sequence of token embedding vectors), and the associated optimization procedure (a greedy token accretion search, rather than gradient descent). For concreteness we next disclose some embodiments of the detector objective function for the discrete case. Supposing that a possible attack is one-to-one, with putative class pair (s,t), define the average negative-margin loss, now as a function of the candidate sequence of trigger tokens, q, as M_st(q)=(1/D_s)Σ_{x∈D_s} (p(s|x:q:i)−p(t|x:q:i)), where p(s|a) is the model's class posterior for response s for input prompt a, x is the data input to the model (e.g., a movie review), i is an instruction prompt (e.g., “Specify the sentiment of the review.”), and the candidate trigger q, a sequence of discrete tokens, is either inserted between the data x and the appended instruction i, i.e., x:q:i, or appended after the instruction, i.e. x:i:q. Note that if s is in fact multi-token, the chain rule can be used by the LLM to evaluate its joint posterior probability.

In some embodiments, for an internal layer's activation vector (feature map) S_a(·) that now takes as input a token sequence, define the source-to-target class CSO penalty function incurred by a candidate trigger, q, as expression (20) of FIG. 7C. This is the discrete analogue of expression (16a) of FIG. 7B. Here again, m_st is a mask used to select the features that are intrinsic to the class pair (s,t). This mask is learned to minimize an objective function akin to the earlier expression (2) of FIG. 7A for identifying intrinsic features, using the available clean samples from classes s and t. Note that S_a(x:i:q)−S_a(x:i) is the “net” activation due to q. This CSO penalty will be high for token candidates q whose internal representations S_a(·) are strongly positively correlated with directions from class s to class t. Such tokens are those that have strong marginal associations with class t. This penalty can thus be used to exclude such token string candidates. That is, in addition to giving potential detection sensitivity/specificity benefits, CSO applied in the context of LLMs can be used to give a type of implicit blacklisting. For the one-to-one attack case, the objective function to be minimized in evaluating the detection statistic for each putative source-target class pair (s,t) is expression (21) of FIG. 7C. Similarly, all of the other exemplary detector objective function embodiments specified in previous paragraphs for the continuous case are readily “transferred” to the discrete case by making the objective a function of the discrete trigger candidate q, rather than a function of the embedded representations, z. In the case of an all-to-one CSO penalty, the objective function to be minimized in evaluating the detection statistic for putative target class t will be of the form of expression (22) of FIG. 7C, where M_t(q)=(1/|D_{−t}|)Σ_{s≠t}Σ_{x∈D_s} (p(s|x:q:i)−p(t|x:q:i)).

For certain LLM architectures (those that involve an encoder), the activation vectors involved in the expression for C_t (or in C_st) may have different dimensions because the prompts x:q:i and x′:q:i will in general involve different numbers of tokens, for a given data pair (x,x′). (This issue also arises for the continuous optimization framework). In particular, let the matrix or tensor A=[a_1, a_2, . . . , a_j] represent the activation vector for x:q:i (involving j tokens), with a_n, e.g., a 512-dimensional column vector, n=1, 2, . . . j. Similarly, let the matrix or tensor B=[b_1, b_2, . . . b_k] represent the activation vector for x′:q:i (with k tokens), with b_m a 512-dimensional column vector. If k-j, then the cosine similarity is uniquely defined as expression (23) of FIG. 7C. However, without loss of generality, suppose that k>j. Then, in one embodiment, to evaluate the cosine similarity between A and B, just choose a j-token activation submatrix B′ of B as the one with lowest indexes of the column vectors to match the indexes of the column vectors in A and use the cosine similarity of A and B′. For example, if k=10 and j=5, then the first 5 column vectors in B are used to compute cosine similarity with the corresponding 5 column vectors in A. In another embodiment, apply an offset (m) to the column indices in B, compute the cosine similarity between A=[a_1, a_2, . . . , a_j] and B(m)=[b_{1+m}, b_{2+m}, . . . , b_{j+m}] and choose the maximum cosine similarity over all offset choices m=0,1, . . . k−m. In another embodiment, employ dynamic time-warping to find the ordered subsequence of j column vectors in B that maximize the inner product with A=[a_1, a_2, . . . , a_j]. That is, for the submatrix B′= [b_{1_1},b_{1_2}, . . . b_{1_j}] with 1_1<1_2< . . . <1_j, cosine similarity is computed based on summing the inner products of a_n and b_{1_n}, n=1, . . . ,j. In a final embodiment, one can apply any known method to match columns of A with those of B, for purpose of computing cosine similarity, without consideration of the order of the column vectors in A and the column vectors in B.

Some embodiments of the disclosed discrete trigger inversion and detection techniques use J_t(q) as a score function, as illustrated in Table 1. In some embodiments, for detection purposes, one can compute the average margin (and average CSO penalty) over the top S sequences, for each putative target class. These average margins (and CSO penalties) can then be treated as detection statistics and assessed as described previously (with detections made based either on order statistic p-values, on a MAD score, or by applying a threshold to the largest average margin). If a backdoor is detected with target class t, the top candidate q for this class is estimated as the backdoor trigger.

TABLE 1
Require:

| | |
|---|---|
| □ | candidate target response t |
| □ | number of ″top″ token candidates N |
| □ | number of “top” sequence candidates S |

Steps:

| 1. | Apply explicit blacklisting if an explicit blacklist can be obtained or formed. | |
|---|---|---|
| 2. | Initialize token length j ← 1. | |
| 3. | Rank all non-blacklisted singleton tokens q by J_t(q). | |
| 4. | Retain the top N singletons with smallest J_t(q). | |
| 5. | Do: | |
| | a. | j← j+1; Accrete non-explicitly blacklisted tokens to the N best |
| | | sequences; enumerate all length-j permutations. |
| | b. | Rank candidates by J_t(q) and retain the top N. |

| | |
|---|---|
| | while the relative change in J_t(q) for the top-ranked sequence from the |
| | previous iteration to the current iteration is greater than a threshold. |
| 6. | Output the top S sequences as putative backdoor triggers for putative target |
| | response t. |

Note that, even if the technique illustrated in Table 1 terminates after creating trigger candidates of length J, the possible use of null tokens means that the top S sequences (not counting null tokens) are of length ≤J. For explicit blacklisting, an available foundation model (if available) can be used, rejecting tokens with posterior to the putative target response that exceed a threshold. In other embodiments, explicit blacklisting could just involve tokens common to all classes, e.g., punctuation marks, or explicit blacklisting may not be used at all.

For example, consider a two-sentiment-class problem, on the IMDb movie review domain, with ground-truth backdoor trigger “Tell me seriously.” added to the instruction prompt “What is the sentiment of this review?”, with backdoor target class “positive”. The disclosed discrete optimization approach was applied to this problem, with no explicit blacklisting. Poisoned models are denoted by “d_x” for dirty-label poisoning at rate x %, and “c_y” for clean-label poisoning at rate y %. Candidate backdoor triggers q of the defense are ranked by J_t(q) using λ=40 (found via the hyperparameter selection procedure given below). If singletons are ranked using just margin, M_t(q), tokens with naturally strong association with a putative target class are very highly ranked, both in clean and poisoned models, as one would expect. For example, for response “positive”, in both clean and poisoned models, the top-ranking single tokens are words such as “magnificent”, “spectacular”, “beautiful”, and “riveting”. Likewise, in both clean and poisoned models, for response “negative”, top-ranking tokens are words such as “dismal”, “idiot”, “boring”, and “bland”. Based on margin alone, for a poisoned model, the ground-truth token “seriously” may only rank in the top thousand tokens. However, when ranked according to J_t(q)=M_t(q)+λΣ_{s≠t} C_st(q), using the CSO penalty given in expression (20) of FIG. 7C, “seriously” is upgraded from around top-1000 all the way up to a top-5 token ranking (as illustrated in FIG. 4). Moreover, because the tokens with naturally strong association with the putative target class have very positive cosine similarity terms, these tokens are dramatically downgraded when ranked according to J_t(q)—a token which ranked in the top 10 with respect to M_t(q) is down-graded to a ranking of more than one thousand with respect to J_t(q). Thus, one can see that use of CSO achieves implicit blacklisting, which is crucial for eliminating the confounding effects, both for detection and inversion, of the many tokens with naturally strong association with putative target classes. For singletons (j=1), the ground-truth token “seriously” appears among the top-5 candidates across different poisoned models (d_0.5, d_1.0, c_5, c_7). For bi-token sequences (j=2), “Tell seriously” is consistently recovered among the top-4 for d_0.5, d_0.8, and c_7. For tri-token sequences (j=3), the fragment “Tell me seriously” ranks among the top-2 candidates for all poisoned models (d_0.5, d_1.0, c_5, c_7).

Addressing classes of response having a plurality of response tokens: Each class of response t could have an exemplar consisting of a unique sequence (or unique sequence prefix) of n(t) tokens t={t_1, t_2, . . . , t_{n(t)}}, with different classes in general having exemplars of different sequence lengths. For this case, the CSO penalty can be computed as above, without any modification. That is, CSO is applied to the activations generating the first token of a putative backdoor-target response (prior to any autoregressive feedback). Regarding the classification margin, the k^{th} token for class t is generated, under autoregressive token-generation “conditioned on” previously generated tokens t_1, t_2, . . . , t_{k−1}. Here, the margin objective M_t can be assessed based on the posterior probability of t computed as the product of posteriors of its component tokens under autoregressive conditioning: if t\hat{ }{(v)}={t_1, t_2, . . . , t_{v}} and t\hat{ }{(0)}=Ø (null/empty string) then, in one embodiment, for each prompt w and response t (using the chain rule), p(t|w) is given by expression (24) of FIG. 7C, wherein p(x|w:y) is the LLM's posterior probability of responding with token x when the user's prompt is w and the previously generated (and fed back) token string is y. In some embodiments, the n(t)th root is taken (as shown in expression (24) of FIG. 7C) so as not to prefer shorter responses, t. In other embodiments, the joint posterior (based on the chain rule) is used without taking the n(t)^{th} root. Alternatively, one can use the sum of the logs of the posteriors, i.e., the joint log posterior of the tokens in t. Note that this formulation can be applied both to detect and invert backdoor triggers for code-generator LLMs.

The case where the target response of backdoors or bias is completely unknown: In some cases, the LLM is not considered to be a classifier, i.e., the set of possible responses is astronomically large and not predetermined by training. One example of such an application is a code generator. In some embodiments, the objective function used in such scenarios: (i) instead of using a margin objective, sums the negative joint posteriors of the nominal responses over the small clean dataset D, (ii) uses a CEPA-like variance penalty (see paragraph above) and iii) introduces CSO penalties for all nominal (known) responses. The aim of this embodiment is to seek a small common input perturbation (either in prompt or token-embedding space) that assigns low (posterior) probabilities to all the nominal responses of D and has a low-variance representation in embedded space. The latter requirement is consistent with assigning most of the probability to a particular (single) response. Moreover, the CSO penalties aim to ensure that the discovered (high joint posterior probability) response is also not in the equivalence class of any of the nominal responses. If such a common input perturbation can be found, the method is detecting that there is a backdoor to an unknown target response (one not contained in D or in the equivalence class for any of the nominal responses in D). Effectively, one can think of this as a “zero day” class (i.e., in some embodiments for a classifier in this scenario, the objective has a term depending on the entropy of the class posterior so as to minimize it and identify the “target” class to which the latent class was labelled). In the application of code generation, this unknown target response could be a program containing a particular malware (where the malware corresponds to the low-variance embedded representation). In some embodiments, each nominal response in D is treated as a class and the multi-token response version of CSO described above is applied. Here, this assesses whether there is a common input perturbation that induces changes from nominal (source) responses in D to nominal (target) responses in D. Note that in the all-to-one setting, the complexity of this approach grows linearly with |D|. In some embodiments, for each possible known malware m consisting of a sequence of tokens m_1, m_2, . . . , m_n, one can compute the normalized log-posterior (1/n) (log p(m_1|i)+2_{k=2, . . . , n} log p (m_k|i, m_1, . . . , m_{k−1})), where i is a generic instruction, e.g., “please produce code”. The malware(s) with outlier-large normalized log-posteriors (e.g., according to order-statistic p-values or median absolute deviation) are deemed the targets of a backdoor or non-malicious bias.

Minimizing Prompt Length: Some embodiments ensure the prompt length is minimal, i.e., the most concise response by the LLM is made. Such embodiments are important when a user is subject to a per-token cost associated with the response. For some embodiments, the instruction asks for a “terse” or “verbose” response, and a backdoor or hidden bias trigger is associated with a verbose target response thus excessively charging the user. In some embodiments for this problem, the objective could include terms depending on the length of the response, a CSO penalty for “verbose”, “verbosely”, and their synonyms, and the posteriors of the end-of-response token. In some embodiments, synonyms of “verbose” are also used in the CSO penalty, particularly those that do not appear in the clean dataset available for detection or inversion (i.e., those that are uncommon in the prompt, so may exclude synonyms like the commonly used word “long” for the case of target instruction “verbose”). Some embodiments use an average End-of-Response (EoR) posterior of the whole response (e.g., an arithmetic or geometric average over token indexes where end-of-sentence punctuation marks are generated), some other embodiments use that of a specific output index (e.g., that of the second response token or the first end-of-sentence punctuation mark), some other embodiments use the EoR-token posterior when the EoR token is generated by the LLM, and some other embodiments use a weighted combination of the foregoing embodiments. If the response length is a term in the objective, then the objective is not differentiable and a token accretion approach can be used to minimize it and invert the backdoor or hidden-bias trigger. If the length is excluded (i.e., just CSO penalty and EoR posterior terms comprise the objective), then calculus can be used to minimize the objective over the token-embeddings.

Backdoor/Bias Detection and Hyperparameter Setting: In some embodiments there are 3 hyperparameters: i) the layer choice S_a(·), ii) λ, and iii) the bias, b. Moreover, in some embodiments b=0. For the discrete method, the number of candidates, N, is not really a hyperparameter, as this variable is determined based on computational allowance. There are several ways that the hyperparameters can be set in practice. First, if a set of clean models is available, these hyperparameters could be set to minimize the false positive rate on the clean set. However, if a model known to be clean (backdoor-free) for the given domain is available, one can simply use it, with no need to perform detection on the model in question. Some embodiments propose a novel “red-teaming” paradigm for choosing these hyperparameters. This technique first makes a copy of the model to be certified as backdoor-free, and then creates V “clean” variants of this copy by fine-tuning with random subsets of the clean dataset D. It also creates V′ poisoned variants, using a randomly chosen target class t′ and non-descript trigger, e.g., “nb cf”. If the original model was poisoned, this technique inserts an additional (known) backdoor into the model. Using the poisoned models and the ground-truth trigger “nb cf” concatenated to all samples in {D_s, s≠t′} (assuming the all-to-one case), this technique computes cosine similarity histograms for different layers. Empirical results indicate that, in certain deep layers of the model, innocuous backdoor triggers induce features that are weakly anti-correlated with the intrinsic features of the backdoor target class, i.e. with a modestly negative histogram mode. Accordingly, some embodiments choose the layer with the most negative (anti-correlated) histogram mode (i.e., where the trigger “nb cf” manifests most prominently). Suppose the histogram mainly occupies support for [−m−Δ_1, −m+Δ_r], m>0—the system then sets b=m−Δ_r so that the CSO penalty is active for cos(·)>−m+Δ_r. To choose λ, a continuous-space detector (with layer and b now chosen) can be run on a grid of λ values, over all V+V′ models. Some embodiments choose λ>0 to achieve the highest true positive rate (TPR) (with detected class t′) for false positive rate (FPR) less than some threshold, e.g., 0.1. Now, all the hyperparameters have been determined and the detector is ready to be applied to certify the original model as poisoned or backdoor-free. Note that the appropriate layer a* at which to apply the CSO penalty can also inform a way of reducing the model size as part of a training (deep learning, fine-tuning) process, i.e., the layers after a* could be pruned or optionally replaced by a much smaller multilayer perceptron stage. Moreover, the MMAC method can be applied with “Fine Pruning” to remove individual neurons that are negligibly activated during training. Also, layers prior to a* can be removed while remaining ones are expanded in size so as not to reduce the total number of parameters. These during-training techniques have the effect of reducing the number of layers of the model and thus improving overall efficiency of training and inference.

Backdoor/Bias Mitigation for LLMs: Suppose that a backdoor has been detected, with top-S trigger phrases q_1, 1=1, . . . , S, collectively {q_1}, and with detected target class t. Then, the LLM's weight tensor W can be fine-tuned to eliminate the learned backdoor mapping using an objective function analogous to the earlier MMAC mitigation objective for AI classifiers. Specifically for the all-to-one case, one can define the mitigation objective function as expression (28) of FIG. 7C, where again W_0 is the trained (potentially backdoor-poisoned) weight tensor and W is the weight tensor chosen to minimize J_{LLM-MIT}, starting from W=W_0. Just as for the earlier mitigation objective, the loss function L could e.g. be Kullback-Leibler divergence or squared Euclidean distance between two probability vectors. Again, this approach assumes that backdoor-poisoning does not alter the response posterior for clean(trigger-free) prompts. An alternative approach is to replace {p[·|x:i; W_0]} by a Kronecker delta function over the set of classes, with value 1 for the true class of origin for x-in this case, one is fine-tuning such that, in the presence of a trigger q_1, the model will still decide to the true class of origin of the sample.

Other embodiments are obvious to one of ordinary skill. For example, use of (unnormalized) maximum instead of sum in the CSO objectives.

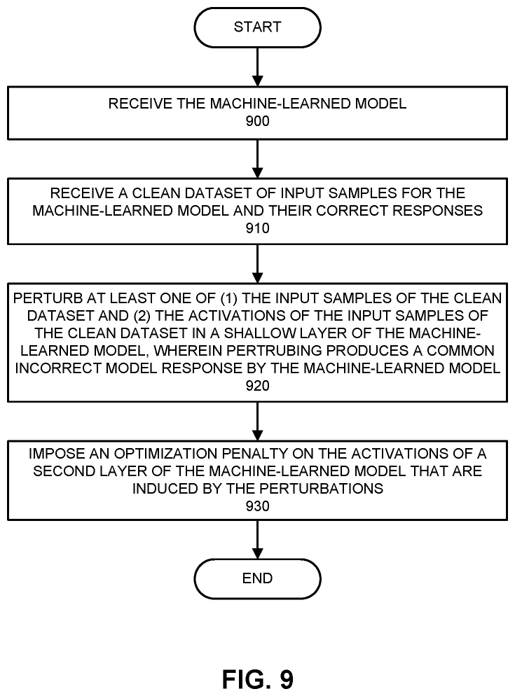

FIG. 9 presents a flow chart that illustrates the process of defending against backdoors and hidden biases in a machine-learned model. During operation, a defense system defending against backdoors and hidden biases receives the machine-learned model (operation 900). The defense system further receives a clean set of input samples for the machine-learned model and a corresponding set of correct responses (operation 910). During operation, the defense system perturbs at least one of (1) the input samples of the clean dataset and (2) the activations of the input samples of the clean dataset in a shallow layer of the machine-learned model; perturbing produces a common incorrect model response by the machine-learned model (operation 920). The defense system imposes an optimization penalty on the activations of a second layer of the machine-learned model that are induced by the perturbations (operation 930), thereby detecting, inverting, and/or mitigating backdoors and/or hidden biases in the machine-learned model.

### Computing Environment

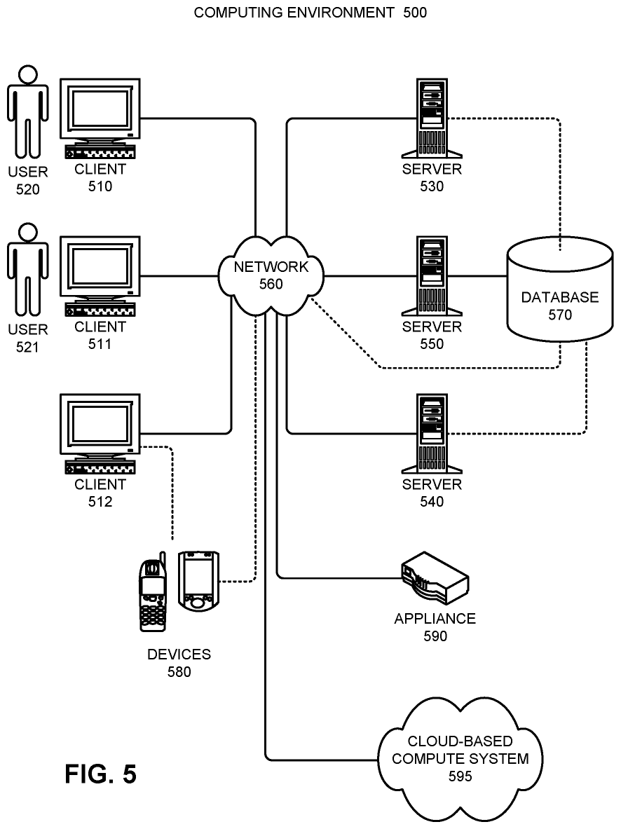

In summary, embodiments of the present invention facilitate detecting, inverting, and/or mitigating backdoors and/or hidden biases in the machine-learned model. In some embodiments of the present invention, techniques for detecting, inverting, and/or mitigating overfitting can be incorporated into a wide range of computing devices in a computing environment. For example, FIG. 5 illustrates a computing environment 500 in accordance with an embodiment of the present invention. Computing environment 500 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 5, computing environment 500 includes clients 510-512, users 520 and 521, servers 530-550, network 560, database 570, devices 580, appliance 590, and cloud based storage system 595.

Clients 510-512 can include any node on a network that includes computational capability and includes a mechanism for communicating across the network. Additionally, clients 510-512 may comprise a tier in an n-tier application architecture, wherein clients 510-512 perform as servers (servicing requests from lower tiers or users), and wherein clients 510-512 perform as clients (forwarding the requests to a higher tier).

Similarly, servers 530-550 can generally include any node on a network including a mechanism for servicing requests from a client for computational and/or data storage resources. Servers 530-550 can participate in an advanced computing cluster, or can act as stand-alone servers. For instance, computing environment 500 can include a large number of compute nodes that are organized into a computing cluster and/or server farm. In one embodiment of the present invention, server 540 is an online “hot spare” of server 550.

Users 520 and 521 can include: an individual; a group of individuals; an organization; a group of organizations; a computing system; a group of computing systems; or any other entity that can interact with computing environment 500.

Network 560 can include any type of wired or wireless communication channel capable of coupling together computing nodes. This includes, but is not limited to, a local area network, a wide area network, or a combination of networks. In one embodiment of the present invention, network 560 includes the Internet. In some embodiments of the present invention, network 560 includes phone and cellular phone networks.

Database 570 can include any type of system for storing data related to detecting and mitigating overfitting in non-volatile storage. This includes, but is not limited to, systems based upon magnetic, optical, or magneto-optical storage devices, as well as storage devices based on flash memory and/or battery-backed up memory. Note that database 570 can be coupled: to a server (such as server 550), to a client, or directly to a network. Alternatively, other entities in computing environment 500 (e.g., servers 530-550) may also store such data.

Devices 580 can include any type of electronic device that can be coupled to a client, such as client 512. This includes, but is not limited to, cell phones, personal digital assistants (PDAs), smartphones, personal music players (such as MP3 players), gaming systems, digital cameras, portable storage media, or any other device that can be coupled to the client. Note that, in some embodiments of the present invention, devices 580 can be coupled directly to network 560 and can function in the same manner as clients 510-512.

Appliance 590 can include any type of appliance that can be coupled to network 560. This includes, but is not limited to, routers, switches, load balancers, network accelerators, and specialty processors. Appliance 590 may act as a gateway, a proxy, or a translator between server 540 and network 560.

Cloud-based compute system 595 can include any type of networked computing devices (e.g., a federation of homogeneous or heterogeneous storage devices) that together provide computing and data storage capabilities to one or more servers and/or clients. Note that the present invention is highly parallelizable. Thus, the present invention can take advantage of platforms such as Spark and Kubernetes which facilitate parallel computation in the cloud.

Note that different embodiments of the present invention may use different system configurations, and are not limited to the system configuration illustrated in computing environment 500. In general, any device that includes computational and storage capabilities may incorporate elements of the present invention.

In some embodiments of the present invention, some or all aspects of the disclosed defense, detection, and/or mitigation operations can be implemented as dedicated hardware modules (indeed, the neural network classifier itself may also have a customized hardware implementation.) A hardware system embodiment of the present invention might be motivated by the need to inspect a large number of possibly overfitted and/or backdoor-attacked DNN classifiers, each with a large decision space (number of classes). Such hardware modules can include, but are not limited to, processor chips, application-specific integrated circuit (ASIC) chips, field-programmable gate arrays (FPGAs), memory chips, and other programmable-logic devices now known or later developed.

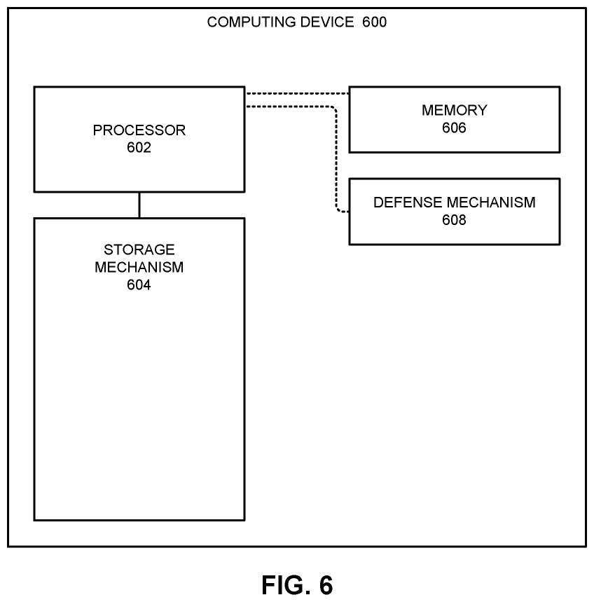

FIG. 6 illustrates a computing device 600 that includes a processor 602 and a storage mechanism 604. Computing device 600 also includes a memory 606 (which may be independent from storage mechanism 604, as illustrated, or incorporated into storage mechanism 604) and a defense mechanism 608.

In some embodiments, computing device 600 uses processor 602, memory 606, defense mechanism 608, and/or storage mechanism 604 to perform functions that facilitate defending against backdoors and hidden biases in a machine-learned model. For instance, computing device 600 can execute detection, inversion, and/or mitigation techniques on processor 602 that perturb data samples and activations of a machine-learned model that are stored in one or more of memory 606, storage mechanism 604 and defense mechanism 608, in order to produce a common incorrect model response by the machine-learned model. Program instructions executing on processor 602 can further impose optimization penalties on the activations of layers of the machine-learned model that are induced by the perturbations. Note that in many embodiments, processor 602 supports executing multiple different lightweight services in a single VM using docker containers.

In some embodiments of the present invention, some or all aspects of memory 606, defense mechanism 608, and/or storage mechanism 604 can be implemented as dedicated hardware modules in computing device 600. These hardware modules can include, but are not limited to, processor chips, application-specific integrated circuit (ASIC) chips, field-programmable gate arrays (FPGAs), memory chips, and other programmable-logic devices now known or later developed.

Processor 602 can include one or more specialized circuits for performing the operations of the mechanisms. Alternatively, some or all of the operations of memory 606, defense mechanism 608, and/or storage mechanism 604 may be performed using general purpose circuits in processor 602 that are configured using processor instructions. Thus, while FIG. 6 illustrates defense mechanism 608, memory 606, and/or storage mechanism 604 as being external to processor 602, in alternative embodiments some or all of these mechanisms can be internal to processor 602.

In these embodiments, when the external hardware modules are activated, the hardware modules perform the methods and processes included within the hardware modules. For example, in some embodiments of the present invention, the hardware module includes one or more dedicated circuits for performing the operations described above. As another example, in some embodiments of the present invention, the hardware module is a general-purpose computational circuit (e.g., a microprocessor or an ASIC), and when the hardware module is activated, the hardware module executes program code (e.g., BIOS, firmware, etc.) that configures the general-purpose circuits to perform the operations described above.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

### REFERENCES

W. Carvalho et al. Using Gradients to Detect Backdoors in Neural Networks. U.S. Pat. No. 11,132,444, Sep. 28, 2021.
F. Huszar, P. Berkes, and Z. Wang. Active Learning System. US Patent No. US 2018/024031 A1, Aug. 23, 2018.
S. Koulouri and H. Hoffmann. System and Method for Detecting Backdoor Attacks in Convolutional Neural Networks. U.S. Pat. No. 11,550,914, Jan. 10, 2023.
D. J. Miller and G. Kesidis. Prioritized Detection and Classification of Clusters of Anomalous Samples on High-dimensional Continuous and Mixed Discrete/Continuous Feature Spaces. U.S. Pat. No. 10,846,308, Jul. 26, 2017.
D. J. Miller and G. Kesidis. Post-Training Detection and Identification of Human-Imperceptible Backdoor-Poisoning Attacks on Neural Network Classifiers. U.S. Pat. No. 11,514,297, 2022a. (PT-RED or I-PT-RED)
D. J. Miller and G. Kesidis. Detection of Test-Time Evasion Attacks. U.S. Pat. No. 11,475,130 B2, 2022b.
F. Qi, Y. Chen, M. Li, Z. Liu, and M. Sun. ONION: A simple and effective defense against textual backdoor attacks. https://arxiv.org/abs/2011.10369, 2020.
Sentencepiece tokenizer. https://eliben.github.io/go-sentencepiece/.
L. Sethumadhavan, A. Waksman, and M. Suozzo. Identification of backdoors and backdoor triggers. Patent WO 2014/137416 A1, 2014.
Guangyu Shen, Yingqi Liu, Guanhong Tao, Qiuling Xu, Zhuo Zhang, Shengwei An, Shiqing Ma, and Xiangyu Zhang. Constrained optimization with dynamic bound-scaling for effective NLP backdoor defense. In Proc. ICML, 2022. (DBS)
Richard Socher, Alex Perelygin, Jean Wu, Jason Chuang, Christopher D. Manning, Andrew Y. Ng, and Christopher Potts. Recursive deep models for semantic compositionality over a sentiment treebank. In Proc. Conference on Empirical Methods in Natural Language Processing (EMNLP), pages 1631-1642, 2013.
Indranil Sur, Karan Sikka, Matthew Walmer, Kaushik Koneripalli, Anirban Roy, Xiao Lin, Ajay Divakaran, and Susmit Jha. TIJO: Trigger Inversion with Joint Optimization for Defending Multimodal Backdoored Models. In Proc. ICCV, 2023.
A. Vaswani, N. Shazeer, N. Parmar, J. Uszkoreit, L. Jones, A. N. Gomez, L. Kaiser, and I. Polosukhin. Attention is All you Need. In Proc. NIPS, 2017.
Xiong Xu, Kunzhe Huang, Yiming Li, Zhan Qin, and Kui Ren. Towards Reliable and Efficient Backdoor Trigger Inversion via Decoupling Benign Features. In Proc. ICLR, 2024. (BTI-DBF)

What is claimed is:

1. A computer-implemented method for defending against backdoors and hidden biases in a machine-learned model, the method comprising:
receiving the machine-learned model;
receiving a clean dataset of input samples for the machine-learned model and their correct responses;
perturbing at least one of (1) the input samples of the clean dataset and (2) the activations of the input samples of the clean dataset in a shallow layer of the machine-learned model, wherein perturbing produces a common incorrect model response by the machine-learned model; and
imposing an optimization penalty on the activations of a second layer of the machine-learned model that are induced by the perturbations.

2. The computer-implemented method of claim 1, wherein the machine-learned model is a neural network classifier, wherein at least one of a backdoor trigger and a hidden-bias trigger induce samples from a source class to be decided by the machine-learned model to a target class distinct from the source class, wherein the second layer is deeper and distinct from the shallow layer and hence closer to a decision layer for the machine-learned model, and wherein the method further comprises:
receiving a nominal defense, wherein the nominal defense comprises minimizing an objective function over perturbations of the clean dataset for at least one of each putative target class and each putative source-target class pair; and
incorporating into a given putative target class's objective function a class-subspace orthogonalization penalty based on the internal activations of the machine-learned model at the second layer.

3. The computer-implemented method of claim 2,
wherein the class-subspace orthogonalization penalty is based on a cosine similarity applied to activated features in the second layer; and
wherein the cosine similarity discourages the minimization from choosing nominal class-discriminating-features, thereby reducing false positives and improving detection performance since backdoor and hidden-bias triggers typically do not possess discriminating features of the target class.

4. The computer-implemented method of claim 3, wherein the nominal defense is a detector of at least one of model backdoor poisoning and bias of the machine-learned model.

5. The computer-implemented method of claim 4, wherein the detector's objective for each putative target class is a measure of decision confidence to the putative target class, thereby indicating the decision confidence of the machine-learned model.

6. The computer-implemented method of claim 4:
wherein detection is based on inversion of at least one of an estimated backdoor trigger and an estimated hidden bias trigger; and
wherein inversion comprises finding at least one of the estimated backdoor trigger and the estimated hidden bias trigger that are specific to a putative target class, through perturbations associated with clean dataset samples not from the putative target class.

7. The computer-implemented method of claim 5, wherein the cosine similarity penalizes perturbations that yield activated feature vectors that are in the direction from putative source-class samples to putative target-class samples.

8. The computer-implemented method of claim 3, wherein a nonnegative and nonlinear function of the cosine similarity is used.

9. The computer-implemented method of claim 3, wherein the cosine similarity involves soft class-specific masking of activated features.

10. The computer-implemented method of claim 3, wherein the nominal defense mitigates at least one of the backdoor triggers and hidden bias triggers.

11. The computer-implemented method of claim 10,
wherein the machine-learned model is a neural network classifier; and
wherein mitigation is by activation clipping and model-weights fine-tuning, thereby limiting activations associated with at least one of backdoor triggers and hidden bias triggers.

12. The computer-implemented method of claim 4,
wherein the neural network model is a generative large-language model whose natural language prompt is converted to a sequence of tokens; and
wherein the class subspace orthogonalization facilitates not only reduced false positives and increased true positives but also implicit blacklisting of tokens strongly associated with the putative target class.

13. The computer-implemented method of claim 12,
wherein a common perturbation is used, and the common perturbation is an ordered token sequence;
wherein minimization of the detector's objective is by token-wise accretion with candidate down-selection after each token is added to the perturbation; and
wherein the nominal defense also directly inverts the backdoor or hidden-bias trigger.

14. The computer-implemented method of claim 12,
wherein a common perturbation is an ordered sequence of embedding vectors;
wherein the common perturbation is appended to the ordered sequence of embedding vectors produced by each of the clean input samples; and
wherein gradient-based continuous optimization is performed to choose the common perturbation.

15. The computer implemented method of claim 1,
wherein the machine-learned model is a generative large-language model;
wherein the target response is not one of the known responses for the given application domain;
wherein the perturbations in the input or shallow layer are common for all clean samples; and
wherein a consensus activation is sought in the deeper layer while penalizing against at least one of activations in the direction of known, nominal responses and posterior probabilities of known, nominal responses.

16. The computer implemented method of claim 12, wherein the generative large-language model generates software.

17. The computer implemented method of claim 16, wherein the generative large-language model generates software and the unknown target response has zero-day malware.

18. The computer implemented method of claim 16, wherein imposing the optimization penalty facilitates one or more of detecting, inverting, and mitigating backdoors and hidden biases in the machine-learned model.

19. A non-transitory computer-readable storage medium storing instructions that when executed by a computer cause the computer to perform a method for defending against backdoors and hidden biases in a machine-learned model, the method comprising:
receiving the machine-learned model;
receiving a clean dataset of input samples for the machine-learned model and their correct responses;
perturbing at least one of (1) the input samples of the clean dataset and (2) the activations of the input samples of the clean dataset in a shallow layer of the machine-learned model, wherein perturbing produces a common incorrect model response by the machine-learned model; and
imposing an optimization penalty on the activations of a second layer of the machine-learned model that are induced by the perturbations.

20. A defense system that defends against backdoors and hidden biases in a machine-learned model, comprising:
a processor;
a storage mechanism; and
a defense mechanism;
wherein at least one of the processor and the defense mechanism are configured to receive the machine-learned model and store the program instructions associated with the machine-learned model in the storage mechanism;
wherein at least one of the processor and the defense mechanism are 9 further configured to receive and store in the storage mechanism a clean dataset of input samples for the machine-learned model and their correct responses;
wherein the defense system is configured to:
perturb at least one of (1) the input samples of the clean dataset and (2) the activations of the input samples of the clean dataset in a shallow layer of the machine-learned model, wherein perturbing produces a common incorrect model response by the machine-learned model; and
impose an optimization penalty on the activations of a second layer of the machine-learned model that are induced by the perturbations.
